(19) United States
(12) Patent Application Publication
(10) Pub. No.: US 2002/0103818 A1
(43) Pub. Date: Aug. 1, 2002

(54) Information repository system and method for an internet portal system

(75) Inventor: Bruce Amberden, Fremont, CA (US)

Correspondence Address: Andrew V. Smith, Sierra Patent Group, P.O. Box 6149, Stateline, NV, 89449, US

(73) Assignee: KirkFire, Inc.

(21) Appl. No.: 09/846,692

(22) Filed: Apr. 30, 2001

Related U.S. Application Data
(60) Provisional application No. 60/201,901, filed on May 4, 2000.

(51) Int. Cl. G06F 12/00

(52) U.S. Cl. 707/205

(57) ABSTRACT

A repository portal includes a repository database, file repository and repository APIs handled by a stream as metadata catalog which lists file and database data in the repository. Access to database and file data is possible via the stream. From a user's point of view, the stream provides a common point from which to access and manage both database data and file data, the distinction being limited to differing storage class keywords in the xMIME typing system. The xMIME typing system “extends” the MIME typing system to add the storage class to the general and specific types. A general class keyword is also preferably added to the xMIME expression for distinctly typing different kinds of content.

### PRIORITY

This application claims the benefit of priority to U.S. provisional patent application No. 60/201,901, filed May 4, 2000, which prior application is hereby incorporated by reference.

### BACKGROUND

1. Field of Invention

This invention relates to the central storage of information that is accessed through the internet, specifically, to improved information repository techniques to manage information from diverse sources including files, databases, and other information; and to simplify information access techniques via internet/web-based services.

2. Description of the Related Art

As of Mar. 16, 2001, there were an estimated 116 million server computers connected to the internet and an estimated 431 million individuals accessing the Web. The Web consisted of an estimated two billion public pages with 3.2 million being added daily. According to Netsizer (www.netsizer.com), the number of connected server computers and Web users is expected to increase annually by 50%.

To date, the majority of ‘enterprise’ applications deployed by large corporations has required proprietary software that resides on each user's CPU. The ubiquitous nature of the Web makes it an ideal platform to deliver information to individuals worldwide. To remain viable, proprietary software systems will have to migrate to the Web.

This migration has begun, but efforts to date have focused in large part on ‘Web-enabling’ individual, single-purpose databases that contain only one type of information or file format. The primary challenge now and in the future will be to organize, manage and manipulate vast amounts of dissimilar data and deliver it to individuals authorized to view it via a Web browser.

Existing systems and techniques for delivering information via the Web are expensive, complex, and extremely difficult to manage, particularly as the amount of available information increases. It is desired to have a system that reduces the expense and complexity of managing vast amounts of dissimilar information and provides a much simpler technique for delivering multiple types and formats of information to users worldwide.

In general, the references discussed below are only relevant herein in minor aspects. The references cited and described below typically have some interesting data management item, or some metadata method, or document organization scheme that may describe features that could be alternatively or in combination used with elements of the preferred embodiments described below. For this reason, all of the references cited in this section are hereby incorporated by reference into the detailed description of the preferred embodiment below. Some features of these references are described in summary below:

### Stream Patent

U.S. Pat. No. 6,006,227 issued on Dec. 21, 1999 to Yale University and is entitled Document Stream Operating System. The '227 patent is about building a computer operating system around a stream system, which is a chronologically ordered collection of files. The stream, described in this patent, holds computer files, called ‘documents’, in chronological order for the purposes of storing and retrieving documents. The stream described in this patent is merely a replacement for the standard hierarchical computer file system. The main problem is that information is far more complicated than just a flat, simple collection of documents. No mention of managing file metadata is made and the '227 patent lacks any way to simplify the volume of information that a large collection of documents represents. No mention is made of data stored in other archives, such as databases, nor for handling persistent program data storage needs. The stream described may provide a starting point for generating an understanding of streams disclosed as preferred embodiments below, although the changes, additions, enhancements, improvements, and new technology in streams of the preferred embodiments herein are clearly distinguished and advantageous compared to the description in the '227 patent.

The '227 patent does not strongly relate to the subject matter of the present invention, and in fact, neither do any of the further related art patents described below. The '227 patent is merely a replacement for standard hierarchical file systems, and ignores the importance recognized in the present invention of adding a metadata catalog to manage collections of files. The '227 patent is so focused on replacing existing computer operating systems, that it misses the larger, more important issues of large scale information management described in accordance with the preferred embodiments below.

### Database Structures for Managing Objects/web Pages

U.S. Pat. No. 6,012,067 issued on Jan. 4, 2000 and is entitled Method and Apparatus for Storing and Manipulating Objects in a Plurality of Relational Data Managers on the Web. The '067 patent describes representing and manipulating heterogeneous objects in relational databases over the internet. Objects include business logic applied to query results on other multimedia web objects, like text, audio, or video. This is a very rudimentary database infrastructure. It ignores the whole ability and notion of using a RDMB to mange metadata. The '067 patent is also narrowly focused on object oriented programming and CORBA.

U.S. Pat. No. 6,181,336 B1 issued Jan. 30, 2001 to Silicon Graphics and is drawn to Database-Independent, Scalable, Object-Oriented Architecture and API for Managing Digital Assets. The '336 patent provides an example of a metadata asset management system associated with multimedia assets for managing a multimedia production environment. It is entirely focused on managing the production of video/audio for film, animations, video games, and the like. The disclosed system is designed to integrate third-party software applications to enable them to exchange and share multimedia assets, and to provide a check-in/check-out process to archive and protect multimedia assets. The '336 patent is focused on tools and utilities to create a uniform multimedia production environment. The system disclosed is not suitable and does not scale outside of multimedia production.

U.S. Pat. No. 5,692,141 issued Nov. 27, 1997 to Fuji Xerox Co. and is entitled Groupware System Providing Facilitated Data Transfer Among Common and Individual Work Areas. A groupware system is disclosed for sharing files over a LAN using tables to describe file locations and permissions to copy data files. What is disclosed in the '141 patent could be a precursor to something like Napster.

This second group of related art patents do not even begin to explore the possibilities of a metadata database catalog information management system. In contrast the preferred embodiments below describe an advantageous and desired metadata database catalog information management system.

### Web Services (Calendar & Scheduling)

U.S. Pat. No. 6,064,977 issued May 16, 2000 to IBM and is entitled and is entitled Web Server with Integrated Scheduling and Calendering. The '977 patent describes a method for integrating non-HTML data into a web server and thereby into a client browser. The '977 patent described a redesigns of a web server to include additional code modules to handle non-HTML data, wherein a disclosed module would reformat data into HTML to be sent to a web browser. Lotus Notes is used as an example, and the '977 patent may be a Domino Web Server foundation patent.

U.S. Pat. No. 6,128,645 issued Oct. 3, 2000 to PFN, Inc. and is entitled Hyper and Client Domain Servers. The '645 patent disclosed to set up closely cooperating domain servers or communication servers to control distribution, access, security, filtering, organizing, and display of info across LANs and WANs. These fancy DNS servers do a lot more than just share URLs, IP addresses, and network topology information, they also implement access, security, etc. policies across a network.

U.S. Pat. No. 6,014,135 issued Jan. 11, 2000 to Netscape Communications Corp. and is entitled Collaboration Centric Document Processing Environment Using an Information Centric Visual User Interface and Information Presentation Method. A user interface design is described for simplifying interaction with communications, for scheduling meetings, etc. The '135 patent describes an attempt to manage collaboration over people, time, and documents, as a user interface design. The '135 patent may have something to do with a backend server.

This third group of related art patents does not deal with web-based services. Neither do they deal with backend repository services for making them work efficiently.

### Hyperlinked Document Structures/Databases

U.S. Pat. No. 5,008,853 issued Apr. 16,1991 to Xerox Corporation and is entitled Representation of Collaborative Multi-User Activites Relative to Shared Structured Data Objects in a Networked Workstation Environment. The '853 patent describes a collaborative file server plus client user interface design. This patent describes data objects for managing common ‘Books’ where multiple users can review and edit contents. The disclosed system uses collection of data objects to carry tracking and status info to manage books. The system relies on a networked file system and on closely networked workstations for information sharing. There is a large focus in the '853 patent on a user interface. The system could be precursor to InterLeaf, an old Unix text/file editing system which is not in current favor in the industry.

U.S. Pat. No. 6,038,574 issued Mar. 14, 2000 to Xerox Corporation and is entitled Method and Apparatus for Clustering a Collection of Linked Documents Using Co-Citation Analysis. The disclosed system organizes web documents using link clustering by grouping those documents that share links to the same other documents. The shared links are counted and used as a threshold to establish clusters.

U.S. Pat. No. 6,189,019 B1 issued Feb. 13, 2001 to Microsoft Corporation and is entitled Computer System and Computer-Implemented Process for Presenting Document Connectivity. A system is disclosed for displaying and traversing links between hypertext documents, specifically, those on the Web. The system has outline and link views, mainly concerned with user interface and support code. No attempt is made to understand documents other than by links between documents.

U.S. Pat. No. 6,122,647 issued Sep. 19, 2000 to Perspecta, Inc. and is entitled Dynamic Generation of Contextual Links in Hypertext Documents. A system is described for relating documents and portions of documents via tags or labels which are defined as contextual links between multiple documents as preserved in a knowledge base layered on a document collection. The '647 patent attempts to relate text fragment from multiple documents together. The disclosed system uses an automated morphological analysis to extract terms from text, makes tags, then tries to relate document fragments on the basis of tag matches. The '647 patent describes methods, but does not describe how to organize a knowledge base.

U.S. Pat. No. 5,809,317 issued Sep. 15, 1998 to Intel Corporation and is entitled Creating and Maintaining Hypertext Links Among Heterogeneous Documents by the Establishment of Anchors and Connections Among Anchors. The '317 patent describes a method for hyper linking documents or portions of documents together. Multiple link endpoints or anchors may be part of a specific hyperlink which may link multiple documents together. The disclosed system may be used to create new, dynamic documents from fragments of other documents that participate in specific hyperlinks. The system seems to use and perhaps compete with Object Linking and Embedding of Microsoft.

This fourth group of related art patents is mostly concerned with how to organize documents according to their hyperlinks, or according to some method for measuring congruency between document fragments. They generally disclose systems that manage documents, which are computer files, based upon author provided labels or algorithm- derived labels. No attempt is made in these patents to utilize user/task context to build a more robust set of structural relationships between documents.

### OBJECTS AND ADVANTAGES OF THE PRESENT INVENTION

In view of the above, some objects and advantages of the present invention include:

(1) to provide a repository which can be used to enable, enhance, and render easier collaborative communication, working, and information sharing, for instance, by members of a project team;

(2) to provide a repository which is robust enough to hold and protect very large volumes of information and make that information available 24 hours/day, 365 days/year, in perpetuity;

(3) to provide a secure repository which partitions information into separate, shared, private workspaces to protect people's information and to separately support a plurality of organizations, users, and projects;

(4) to provide a repository that makes it easy to organize, manage, and access information to simplify how users to interact with their information and collaborate with each other;

(5) to provide repository APIs that make it easy to build and maintain internet/web-based services that access information in the repository;

(6) to provide a repository which is able to seemlessly hold information in both computer files and in database records;

(7) to provide a repository which extends the Multipart Internet Mail Extension (MIME) file typing system which applies data typing to data records in databases and which includes the standard MIME file types for files;

(8) to provide a repository which, in conjunction with the Extended MIME (xMIME(TM)) data typing system, provides the ability to create Abstract Data Types in the repository;

(9) to provide a repository which provides the Stream, a metadata table in the repository database, which lists and holds data about every entry in the repository, which manages the disposition of repository entries;

(10) to provide a repository with the Stream which supports the creation of complex, dynamic information structures and clusters, which has data typing capabilities similar to programming languages;

(11) to provide a repository which supports ownership, visibility, and security of information in the repository;

(12) to provide a repository which supports attributes that simplify the categorization, organization, and annotation of information;

(13) to provide a repository which supports version control of entries in the repository;

(14) to provide a repository which can be partitioned into a plurality of interconnected, cooperating repositories that can be placed on a plurality of computers for performance, content, and security reasons;

(15) to provide a repository which can manage itself, including software and other files, database schema, and installation procedures, files, and initial data records.

Further objects and advantages of this invention will become apparent from a consideration of the drawings and ensuing discussion of the preferred embodiments below.

### SUMMARY OF THE INVENTION

In view of the above, a data repository portal running on one or more computers for managing information is provided. The portal includes a set of repository API's for interfacing the repository with a computer network, a file repository containing file data, and a repository database. The repository database includes a stream table having entries for the file data and for database data, such that the file data and the database data are managed within the same data storage environment.

Another data repository portal running on one or more computers for managing information is further provided. The portal includes a set of repository API's for interfacing the repository portal with a computer network, a file repository containing file data, and a repository database. The repository database includes a stream table having entries for the file data and for database data. The stream entries for the file data and for the database data are indexed according to an extended MIME typing that includes a storage class, along with a general type and a specific type, for distinctly typing the file data and the database data within the same data storage environment.

Another data repository portal running on one or more computers for managing information is further provided. The portal includes a set of repository API's for interfacing the repository with a computer network, a file repository containing file data, and a repository database. The repository database includes a stream table having entries for the file data and for database data. The stream entries for the file data and for the database data are indexed according to an extended MIME typing that includes a general class, along with a general type and a specific type, for distinctly classifying kinds of content within the same data storage environment.

A repository database stored on one or more computers is also provided. The repository database includes a stream table having entries for file data and for database data, such that the file data and the database data are managed within the same data storage environment.

Another repository database stored on one or more computers is further provided. The repository database includes a stream table having entries for file data and for database data. The stream entries for the file data and for the database data are indexed according to an extended MIME typing that includes a storage class, along with a general type and a specific type, for distinctly typing the file data and the database data within the same data storage environment.

Another repository database stored on one or more computers is additionally provided. The repository database includes a stream table having entries for file data and for database data. The stream entries for the file data and for the database data are indexed according to an extended MIME typing that includes a general class, along with a general type and a specific type, for distinctly classifying kinds of content within the same data storage environment.

Another repository database stored on one or more computers is also provided. The repository database includes a stream table having entries for managing data within a data storage environment including at least one other repository database. The repository databases within the data storage environment have stream connector entries for establishing a connection between the repository databases.

Another repository database stored on one or more computers is further provided. The repository database includes a stream table having entries for managing data within a data storage environment that are indexed according to an extended MIME typing that includes a storage class, along with a general type and a specific type. The data storage environment includes at least one additional repository database. The repository databases within the data storage environment have stream connector entries for establishing a connection between the repository databases.

Another repository database stored on one or more computers is also provided. The repository database includes a stream table having entries for managing data within a data storage environment that are indexed according to an extended MIME typing that includes a general class, along with a general type and a specific type. The data storage environment includes at least one additional repository database. The repository databases within the data storage environment have stream connector entries for establishing a connection between the repository databases.

Another repository database stored on one or more computers is also provided. The repository database includes a system table space and multiple content table spaces. The system table space includes a system stream table having entries for file data and for database data, such that the file data and the database data are managed within the same data storage environment.

An additional repository database stored on one or more computers is provided. The repository database includes a system table space and multiple content table spaces. The system table space includes a system stream table having entries for file data and for database data. The stream entries for the file data and for the database data are indexed according to an extended MIME typing that includes a storage class, along with a general type and a specific type, for distinctly typing the file data and the database data within the same data storage environment.

Another repository database stored on one or more computers is provided. The repository database includes a system table space and multiple content table spaces. The system table space includes a system stream table having entries for file data and for database data. The stream entries for the file data and for the database data are indexed according to an extended MIME typing that includes a general class, along with a general type and a specific type, for distinctly classifying kinds of content within the same data storage environment.

An additional repository database stored on one or more computers is provided. The repository database includes a system table space and multiple content table spaces. The system table space includes a system stream table having entries for file data and for database data such that the file data and the database data are managed within a same data storage environment. The content table spaces each includes a content table space stream table. The system stream table and the content table space stream tables further include stream connector entries for establishing connections therebetween.

Another repository database stored on one or more computers is additionally provided. The repository database includes a system table space and multiple content table spaces. The system table space includes a system stream table having entries for file data and for database data. The stream entries for the file data and for the database data are indexed according to an extended MIME typing that includes a storage class, along with a general type and a specific type, for distinctly typing the file data and the database data within the same data storage environment. The content table spaces each include a content table space stream table, and the system stream table and the content table space stream tables also include stream connector entries for establishing connections therebetween.

Another repository database stored on one or more computers is provided. The repository database includes a system table space and multiple content table spaces. The system table space includes a system stream table having entries for file data and for database data. The stream entries for the file data and for the database data are indexed according to an extended MIME typing that includes a general class, along with a general type and a specific type, for distinctly classifying kinds of content within the same data storage environment. The content table spaces each include a content table space stream table, and the system stream table and the content table space stream tables also include stream connector entries for establishing connections therebetween.

A stream table stored on one or more computers is also provided for managing data within a data storage environment. The stream table includes entries for file data and for database data, such that the file data and the database data are managed within the same data storage environment.

Another stream table stored on one or more computers for managing data within a data storage environment is further provided. The stream table includes stream entries for file data and for database data. The stream entries for the file data and for the database data are indexed according to an extended MIME typing that includes a storage class, along with a general type and a specific type, for distinctly typing the file data and the database data within the same said data storage environment.

Another stream table stored on one or more computers for managing data within a data storage environment is also provided. The stream includes stream entries for file data and for database data. The stream entries for the file data and for the database data are indexed according to an extended MIME typing that includes a general class, along with a general type and a specific type, for distinctly classifying kinds of content within the same data storage environment.

A method for managing data in a repository portal including a file repository module, a repository database and a set of APIs is also provided. The method includes storing file data in a file repository module of the repository portal, storing database data in a repository database of said repository portal, and indexing the file data and the database data in a same stream table for managing the file data and the database data in the same data storage environment.

Another method is provided for managing data in a repository portal including a file repository module, a repository database and a set of APIs. The method includes storing file data in a file repository module of the repository portal, storing database data in a repository database of the repository Portal, and indexing the file data and the database data according to an extended MIME typing that includes a storage class, along with a general type and a specific type, for distinctly typing the file data and the database data within the same data storage environment.

Another method is provided for managing data in a repository portal including a file repository module, a repository database and a set of APIs. The method includes storing file data in a file repository module of the repository portal, storing database data in a repository database of the repository portal, and indexing the file data and the database data according to an extended MIME typing that includes a general class, along with a general type and a specific type, for distinctly classifying kinds of content within the same data storage environment.

A further method is provided for managing data. The method includes storing file data and storing database data, and indexing the file data and the database data in a same stream table for managing the file data and the database data in the same data storage environment.

Another method is provided for managing data. The method includes storing file data and storing database data, and indexing the file data and the database data according to an extended MIME typing that includes a storage class, along with a general type and a specific type, for distinctly typing the file data and the database data within the same data storage environment.

A further method is provided for managing data. The method includes storing file data and storing database data, and indexing the file data and the database data according to an extended MIME typing that includes a storage class, along with a general type and a specific type, for distinctly typing the file data and the database data within the same data storage environment. The indexing includes storing entries for the file data and the database data in the same stream table for managing the file data and the database data in the same data storage environment.

A further method is provided for managing data. The method includes storing file data and storing database data, and indexing the file data and the database data according to an extended MIME typing that includes a general class, along with a general type and a specific type, for distinctly classifying different kinds of content within the same data storage environment.

Another method for managing data is provided. The method includes storing file data and storing database data, and indexing the file data and the database data according to an extended MIME typing that includes a general class, along with a general type and a specific type, for distinctly classifying different kinds of content within the same data storage environment. The indexing includes storing entries for the file data and the database data in the same stream table for managing the file data and the database data in the same data storage environment.

A further method for managing data is provided. The method includes indexing file data and database data in the same stream table for managing the file data and the database data in the same data storage environment.

A further method for managing data is provided. The method includes indexing file data and database data according to an extended MIME typing that includes a storage class, along with a general type and a specific type, for distinctly typing the file data and the database data within the same data storage environment.

Another method for managing data is provided. The method includes indexing file data and database data according to an extended MIME typing that includes a storage class, along with a general type and a specific type, for distinctly typing the file data and the database data within the same data storage environment. The indexing includes storing entries for the file data and the database data in the same stream table for managing the file data and the database data in the same data storage environment.

Another method for managing data is provided. The method includes indexing file data and database data according to an extended MIME typing that includes a general class, along with a general type and a specific type, for distinctly classifying different kinds of content within the same data storage environment.

A further method for managing data is provided. The method includes indexing the file data and database data according to an extended MIME typing that includes a general class, along with a general type and a specific type, for distinctly classifying different kinds of content within the same data storage environment. The indexing includes storing entries for the file data and the database data in the same stream table for managing the file data and the database data in the same data storage environment.

A recording medium having a software algorithm stored thereon for providing instructions for one or more processors to perform any of the above methods is also provided.

A computer system including one or more processors and having a software algorithm stored therein for providing instructions for the one or more processors to perform any of the above methods is also provided.

### BRIEF DESCRIPTION OF THE DRAWINGS

FIG. 1 schematically illustrates a portal system conceptual architecture according to a preferred embodiment from a user's point of view, including: users, authentication, services, and repository with workspaces.

FIG. 2 schematically illustrates how multiple tiers of servers that implement the repository of FIG. 1 are laid out on the server computer in accord with a preferred embodiment in relation to surrounding components.

FIG. 3 schematically shows a conceptual configuration of an information repository in accord with a preferred embodiment.

FIG. 4 schematically shows a configuration of repository APIs in accord with a preferred embodiment.

FIG. 5a schematically shows a configuration of repository table spaces in accord with a preferred embodiment.

FIG. 5b schematically shows a configuration of a typical table space in accord with a preferred embodiment.

FIG. 6 schematically shows a configuration of a repository database schema in accord with a preferred embodiment.

FIG. 7 schematically shows a configuration of a stream record in accord with a preferred embodiment.

FIG. 8a schematically shows link fields in a stream record in accord with a preferred embodiment.

FIG. 8b schematically illustrates how a stream table in accord with a preferred embodiment may support three kinds of links between stream entries.

FIG. 9 schematically shows connections between multiple repository streams in accord with a preferred embodiment.

FIG. 10 schematically shows a configuration of file repository file directories in accord with a preferred embodiment.

FIG. 11 schematically shows high level repository/stream features in accord with a preferred embodiment.

FIG. 12 schematically shows a portal schema in accord with a preferred embodiment.

FIG. 13 schematically shows a login-authentication process with interaction with a repository database and stream in accord with a preferred embodiment.

FIG. 14 schematically shows a layout concept of a web-based portal user interface in accord with a preferred embodiment.

FIG. 15 schematically shows a service modular layout and interaction with a repository database in accord with a preferred embodiment.

FIG. 16 schematically shows a conceptual structure of information in accord with a preferred embodiment.

### LIST OF REFERENCE NUMERALS

A list of reference numerals and the names of their respective parts in the drawings is provided below:

1-Repository System Table Space

2-Content Table Spaces

3-Stream Table

4-Abstract Data Type Tables

5-File Repository

6-Stream Record or Stream Entry. The stream entry include both the stream record and the matching content, some file or some other database record(s). The two names are used somewhat interchangeably.

7-Stream ID, Stream Identification Number

8-Data Record

9-Identification Group

10-Date Group

11-Ownership Group

12-Link Group

13-Access Group

14-Disposition Group

15-Metering Group

16-Type Group

17-Location Group

18-Name Group

19-Stream Link Entry

20-SLinkID, Strong Link ID Number

21-WLinkID, Weak Link ID Number

22-Strong Binding Link

23-Weak Binding Link

24-Steam Connector

25-Steam Connection

26-Steam Connection to distant, not shown, streams

27-File Repository Directory

28-File Repository File

29-Service Framework

30-Module for adding, updating, or deleting information in the repository

31-Module for retrieving information from the repository

32-Module for generating HTML document that is sent to user

33-Left side, vertical Navigation Bar

34-Right side Service Display Page

35-Popup Subwindows

36-Information search results list

37-Control Strip with icon buttons

38-Icon buttons

39-Service button

40-Cluster Root

41-Sub-Cluster Root

42-Data Cluster

43-Atomic Data Item

44-Cluster Link

### Incorporation by Reference

Each of the references cited above and below, and including that which is described in the related art description, the above invention summary, the abstract below, and elsewhere herein, is hereby incorporated by reference into the detailed description of the preferred embodiments below, as disclosing alternative embodiments of elements or features of the preferred embodiments not otherwise set forth in detail below. A single one or a combination of two or more of the references cited herein may be consulted to obtain a variation of the preferred embodiments described in the detailed description below and within the scope of the present invention.

### DETAILED DESCRIPTION OF THE PREFERRED EMBODIMENTS

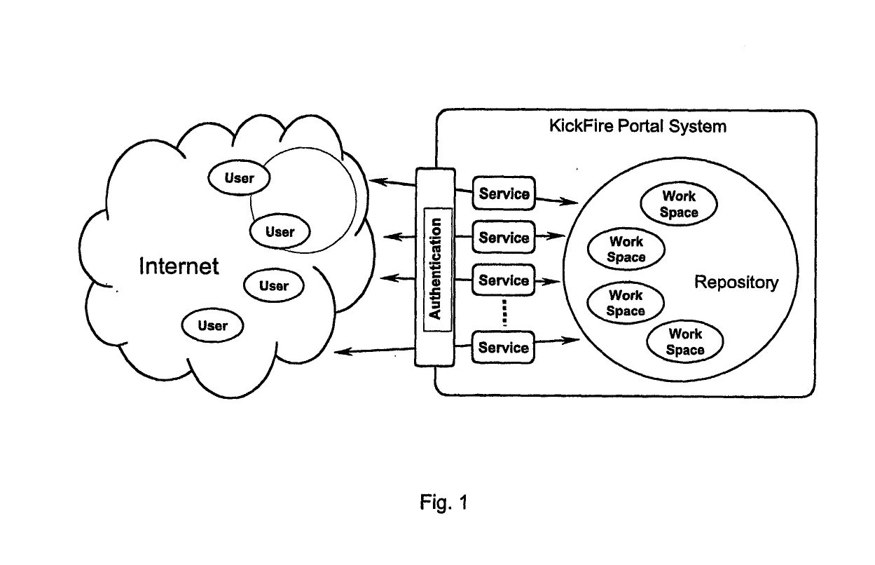

The preferred embodiments describe an information repository that provides access to stored information via internet/web-based portal services. A basic conceptual view according to a preferred embodiment is illustrated in FIG. 1 showing the repository as a component of a portal system. The portal system has services that deliver information from the repository workspaces to users on the internet. The repository comprises a computer file system repository, a repository database, and a set of Application Program Interfaces (API). The portal shown in FIG. 1 also includes an authentication module.

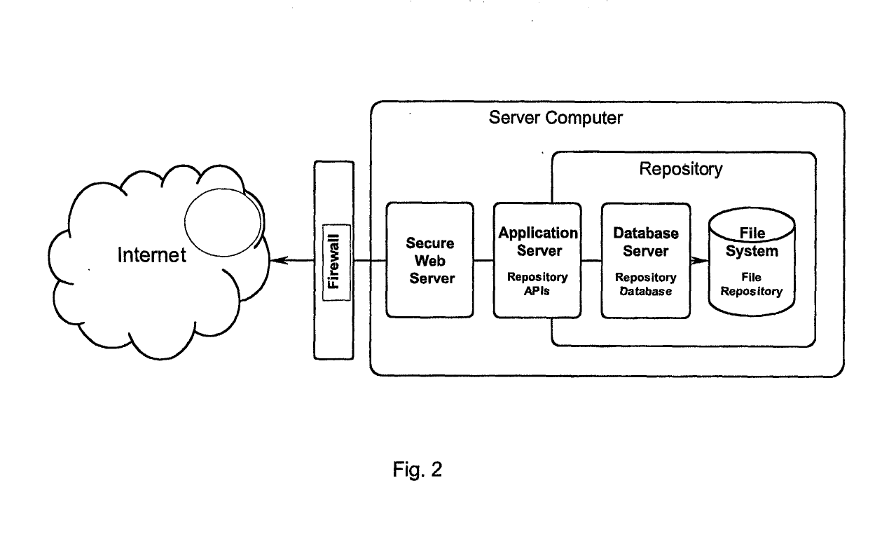

FIG. 2 illustrates how the repository components are laid out on the server computer and how they relate to other components, which are included for context. Each of the servers shown in FIG. 2, application, database, and file system, as well as the secure web server preferably run on the same server computer, shown for connecting to the internet and protected by a firewall. Alternately, all three components could run on a plurality of separate server computers enabling the repository to be partitioned across a plurality of server computers. The preferred embodiment of the repository invention may run on any of Sun Solaris, Windows NT/2000, IBM OS/390, or Linux-based computer servers.

The repository can hold and manage information, software components, that embodies itself. The repository separates information into general classes (via xMIME as described below) that may include a repository component class, portal component class, and a user content class. The repository class and portal class can include files that hold the software that embodies that class. Repository and portal classes are normally not accessible to typical users. The content class defines information that users save into the repository and is generally available to authorized users.

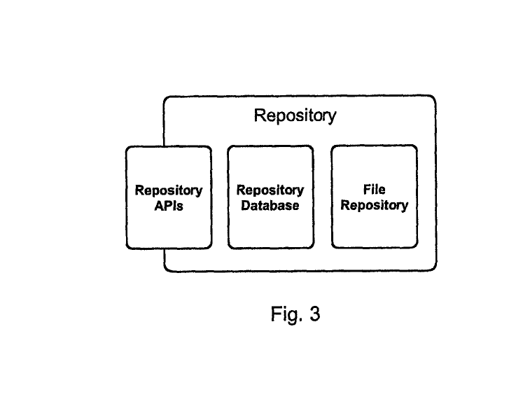

A conceptual embodiment for the preferred repository is shown in FIG. 3. The repository incorporates three major components, a set of repository APIs, a repository database, and a file repository. The repository APIs are implemented in software and provide an interface to the information repository. The repository database is implemented using a standard Relational Database Management (RDBM) system. The file repository is a directory on the server computer's file system. All three repository components may be implemented using off-the-shelf commercial components or open standard technologies. Special care has been taken to work in official ANSI or Open Systems standards so as to be portable between different commercial products.

### Repository API's

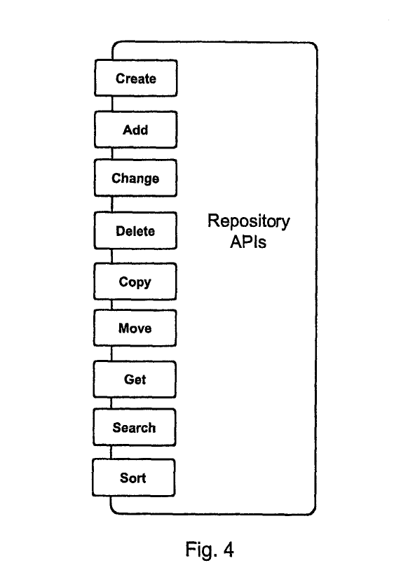

FIG. 4 details the preferred repository APIs. The APIs enable external systems to interact with information in the repository. The preferred embodiment of the repository APIs are implemented using Allaire's Cold Fusion Markup Language (CFML) and ANSI Standard Query Language (SQL). The APIs implement a minimum of nine methods or functions including: Create, Add, Change, Delete, Copy, Move, Get, Search, and Sort. The APIs employ SQL to interact with the repository database and present CFML functions to the external system.

A preferred embodiment of the Standard General Stream API (SGSAPI) is written in a combination of CFML (Cold Fusion Markup Language) and SQL. Other embodiments may employ Server Side JavaScript and ODBC, or Java and JDBC, or C++ and ODBC, or many other language/SQL interfaces to implement the SGSAPI. In our preferred embodiment, CFML runs on the Cold Fusion Application Server which connects to a web server on the front end and to a database server on the backend, as illustrated in FIG. 3.

### Repository Database

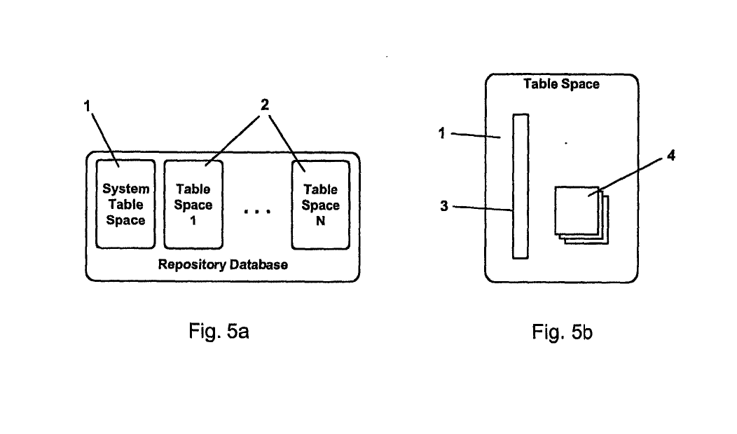

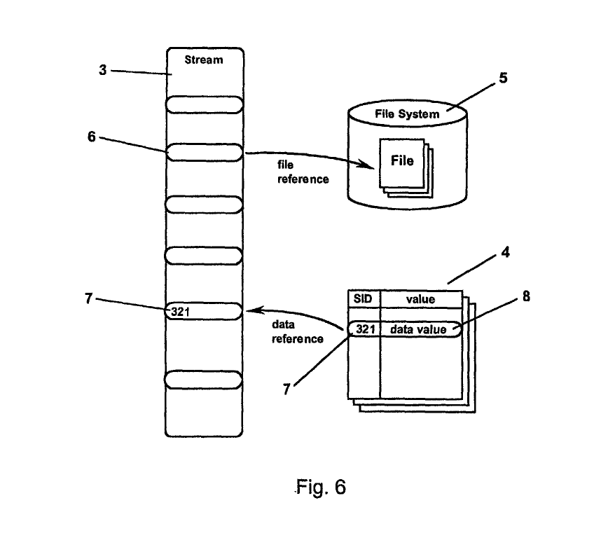

FIGS. 5a, 5b, and 6 detail a preferred embodiment of the repository database. The repository database works in conjunction with the file repository 5 (FIG. 6). The repository database contains a plurality of tablespaces: a System Tablespace 1 (FIG. 5) and a plurality of Content Tablespaces 2 (FIG. 5). Each tablespace has a separate database schema which may be a variation on the standard repository database schema.

Each tablespace may represent a different authorization boundary since each stream can manage it own authorization data. As a user traverses from tablespace to tablespace, or from stream to stream, the user may be required to perform an authentication process before being granted access to the next stream. Under one embodiment, tablespaces could be construed to be synomous with workspaces within some hierarchy of workspaces, with some workspaces also being authorization boundaries.

FIG. 6 illustrates the preferred embodiment of the standard repository database schema. The standard schema contains three types of tables. Each tablespace has at least one Stream table 3, a variable number of Abstract Data Type tables 4, and a standard set of support tables. Each stream entry 6 refers to one file in the file repository 5 or one data record 8 in an Abstract Data Type table. There is an entry in the stream for each file in the file repository and for each data record in the Abstract Data Type tables. Stream entries and data records are joined together by their shared Stream Identification Number (StreamID) 7.

The stream table is the foundation of the information repository and repository database. The stream is a metadata catalog that contains data about everything stored in the repository. The stream lists every entry in the repository; each entry in the list holds metadata (data about data) about some entry in the repository. The metadata includes unique identification, dates about when an item was entered in the repository, or information changes, storage locations, item types, author IDs, and more.

The stream table supports higher levels of organization and structuring of information in the repository. Stream entries can be grouped into dynamic clusters and clusters of clusters, and placed into information structures and constructs.

Tables 1.1-4.2, below, shows an illustrative listing of a repository specification in accordance with a preferred embodiment. The repository specification has four major sections: The Stream, Admin Data Types, Attribute Data Types, and Service Data Types. The stream section has the specification for the stream, stream identifier, stream connector, links, labels, and folders. The admin data type section describes specifications to support organizations, persons, workspaces, and more. The attribute data type section has specification for the basic, built-in data types. The service data types section has specifications for data types that directly support the development and implementation of services that operate over the web.

### Stream Table Definition

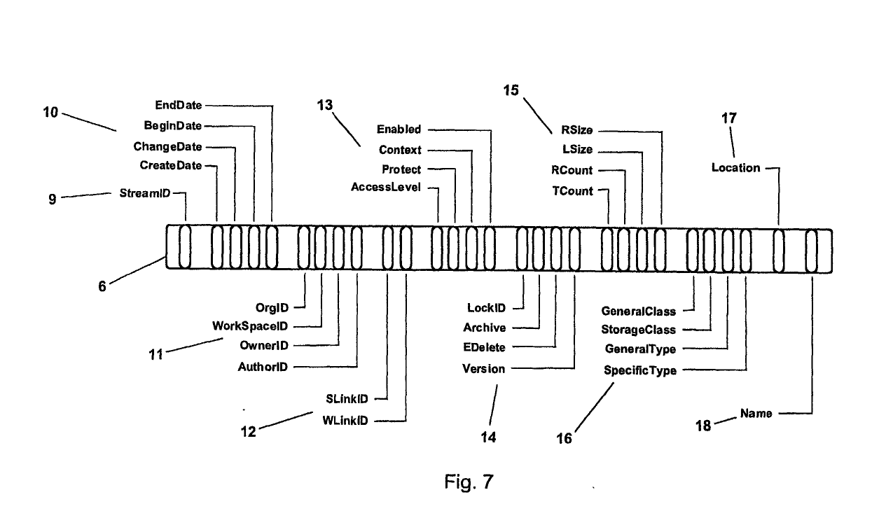

FIG. 7 details the preferred embodiment for the stream record that is implemented in the stream table. The definition of the stream table is part of the repository database schema. There are ten groups of table fields in the stream table. These groups are called Attribute Groups. They are: Identification, Date, Ownership, Link, Access, Disposition, Metering, Type, Location, and Name. These groups are typical of the types of groups employed in the stream record, but this list of groups is not an exhaustive list of potential stream attribute groups.

### Identification Group

The Identification Group 9 (FIG. 7) only has the StreamID field. The StreamID, stream identification number, is an integer value that is incremented and assigned as a unique, sequential, identifier for every new stream entry. The StreamID insures a unique identity for each stream record or entry.

### Date Group

The Date Group 10 (FIG. 7) has the CreateDate, ChangeDate, BeginDate, and EndDate fields. CreateDate is a date-time that is set when a stream entry is created. The ChangeDate, initialized when a stream entry is created, is updated whenever a stream entry is changed. BeginDate specifies the date-time when a stream entry becomes current and EndDate specifies when a stream entry is no longer current or has expired.

### Ownership Group

The Ownership Group 11 (FIG. 7) includes the OrgID, WorkspaceD, OwnerID, and AuthorID fields. The OrgID is the StreamID of the owning organization, WorkspaceID is the StreamID of the owning Workspace, AuthorID is the StreamID of the person who created a stream entry, and OwnerID is the StreamID of the organization, person, or workspace who owns a stream entry if the author is not the owner.

### Link Group

The Link group 12 (FIG. 7) has two link references fields, SLinkID and WLinkID. Links refer to other stream entries by holding the StreamID of the target stream entry. The links are reverse references—as opposed to the usual forward references; links point from child to parent. Links create three kinds of relationships between stream entries: strong binding implemented by SLinkID, weak binding implemented by WLinkID, and indirect binding implemented through stream links.

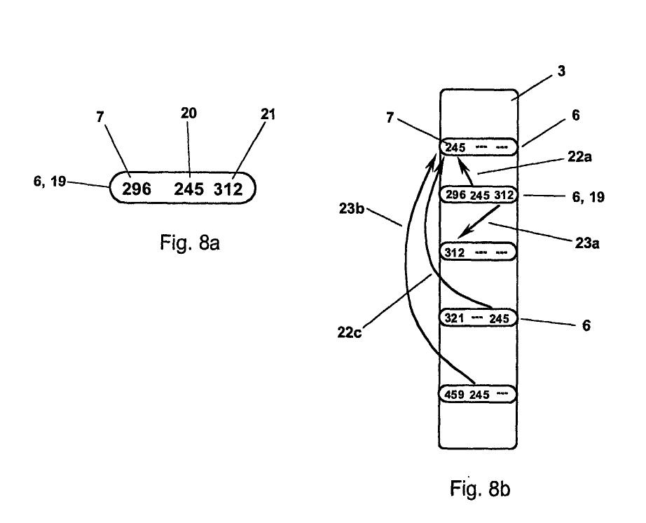

FIG. 8a shows the logical arrangement of StreamID 7, SLinkID 20, and WLinkID 21 within a stream record as used in FIG. 8b. FIG. 8b illustrates the three links types supported in the stream. Stream record at 245 is the target or parent record for the three examples. The stream record at 296 is a stream link that indirectly binds 22a,23a stream record 312 to stream record 245. Stream record 321 is weakly linked 21b to stream record 245, and Stream record 459 is strongly linked 22c to stream record 245.

### Access Group

The Access group 13 (FIG. 7) has AccessLevel, Protect, Context, and Enabled fields. AccessLevel is one of four levels Viewer, User, Admin, and SuperAdmin that controls who has access to specific stream entries. SuperAdmins have the most access, Viewers have the least. Viewers are unable to create or change anything in the repository.

Protect is set to either Private, Read, or Write. Protect controls user stream entry permissions, for example a user must have Write protection to be able to change or delete a stream entry. Context is set to None, Open, Common, Publish.

Context controls the visibility of stream entries. Context set to None limits the visibility of a stream entry to the enclosing workspace. Open context sets visibility to an entire organization. Common context sets visibility to the portals and organizations. Publish context makes stream entries visible to the entire World Wide Web.

Enabled controls access to stream entries. Enable allows Admins and SuperAdmins to turn stream entries on and off. Stream entries that are turned off are not visible to Users or Viewers. Stream entries that are turned off by SuperAdmins are not visible to Admins. The intent of Enable is to allow stream entries to be turned off, made unavailable, without having to delete them. This allows Admins to disable a user or any content that can be re-enabled later when issues are resolved.

### Disposition Group

The Disposition group 14 (FIG. 7) has the LockID, Archive, EDelete, and Version fields. LockID allows someone to lock a stream entry for checkout and/or while editing. Archive indicates that a stream entry is archived or not. EDelete indicates when a stream entry is marked for delete; stream entries marked for delete are no longer accessible. Version indicates a stream entry is under version control and the most recent version number.

### Metering Group

The Metering group 15 (FIG. 7) has the TCount, RCount, LSize, and RSize. TCount and RCount are the total and recent hit counters for a stream entry. LSize and RSize contain the stream entry size in bytes, with LSize holding the size of the stream record and RSize holding the size of the stream entry's content.

### Type Group

The Type group 16 (FIG. 7) has the GeneralClass, StorageClass, GeneralType, and SpecificType fields. These fields are part of the repository's Extended MIME (xMIME) typing system. The preferred embodiment of the xMIME typing system extends the existing open internet standard MIME file typing system in four ways.

### Extended Mime (xMIME) Typing System

The existing MIME typing system expresses file media types with a two part expression:

General Type/Specific Type

where the General Type is a keyword like text, image, video, audio, application, etc.; and the Specific Type is another keyword such as gif, plain, html, etc. Some examples are: text/plain, text/html, image/gif. See MIME type references and specifications (rfc2045, rfc2046, rfc2047, rfc2048, rfc2049, rfc2112, rfc2184, rfc822, and other obsolete MIME specifications).

A first way that xMIME advantageously extends the older system in accordance with a preferred embodiment herein is by adding two new parts to the MIME type expression: General Class and Storage Class. The xMIME expression is:

General Class/Storage Class/General Type/Specific Type

Where the General Class is a keyword like type, portal, content, attribute, foreign, etc.; and the Storage Class is a keyword like file, stream, database, etc. The General Type and Specific Type are the same as before, but more keywords are added to cover a much wider variety of types. Some examples are:

content/file/image/gif

portal/file/text/cfml

content/stream/text/message

content/stream/numeric/real

content/oracle/sales/customer

A second way that xMIME advantageously extends the older system in accordance with a preferred embodiment herein is that the xMIME can also specify type for records in databases. The type prefix content/stream refers to information that exists in the repository database. The type prefix content/oracle refers to database records in an external Oracle database.

A third way that xMIME typing system advantageously extends the old MIME system is by enabling new types to be defined, which are specified using the ‘type’ General Class. New xMIME types can be added at any time and does not require a formal petition to a standards body. This enables xMIME to incorporate and include the entire set of pre-existing MIME types, which makes the xMIME typing system compatable and interoperable with MIME types. Some examples are:

type/file/image/gif

type/file/text/cfml

type/stream/text/message

type/oracle/sales/customer

A fourth way that xMIME typing system advantageously extends the old MIME system is by applying xMIME types to the Abstract Data Type (ADT) tables and ADT data records in the repository database. ADT Data records are joined to entries in the stream and have xMIME specifications that identify their data type. This enables the repository to define and manage persistent information in the stream with a flexibility rivaling programming languages.

### Location Group

The Location group 17 (FIG. 7) has the Location field. Location gives the relative path to content of the stream entry. The path may be a file system path name or a URL.

### Name Group

The Name group 18 (FIG. 7) has the Name field. The Name is the name text assigned to stream entries.

### Abstract Data Types

FIG. 6 illustrates the preferred embodiment for a plurality of Abstract Data Type (ADT) tables 4. Each ADT table follows the same general structure or schema. Each ADT table has an SID (Stream Identification Number) that guarantees uniqueness and a set of data columns grouped as the ‘Value’. Some ADT tables are defined and used by the repository system, some are provided by the repository system as ‘built-in’ types, still others may be defined and used by repository users.

Abstract Data Type tables may be added or removed from the repository database. Typically, the repository database tends to accumulate ADT tables as more and more data types are defined.

These tables are called the Abstract Data Type tables because the set of data columns grouped as the ‘Value’ represent a defined data type in the repository system. The ADT tables are how the repository implements repository data types. The set of data columns may specify any cluster of data field types that are supported by ANSI standard databases. The data field cluster may have any configuration, from just a single data field to a plurality of fields with a plurality of types.

Data records in the Abstract Data Type tables are joined to or refer to StreamIDs in the Stream table. For each repository entry that refers to a data record in an ADT table, the SID in the ADT table is equal to the StreamID in the Stream table. Thus, each and every data record in an Abstract Data Type table has a matching entry in the Stream table. Since the StreamID is unique in the Stream table, then the StreamID guarantees uniqueness in the Abstract Data Type tables.

### Built-in Types

Several important Abstract Data Types are built-in to the repository database to enhance organization of information. These types attach additional data to entries in the stream to enhance information organization, structure, and searchability. The built-in types include Labels, Folders, and Attributes.

Labels are entered into the stream and attached to other stream entries to create a set of searchable categories. Labels may be attached to labels, which enables the creation of searchable label hierarchies. Folders are implemented the same as labels, except folders and labels are a different data types.

Attributes are name-value pairs. Attribute value may be any data type supported by the repository database, including: text, numeric, dates, and others. Attributes are entered into the stream and attached to other stream entries. Attributes belong to the entries to which they are attached. Attributes facilitate the creation of dynamic data structures.

### Repository Network

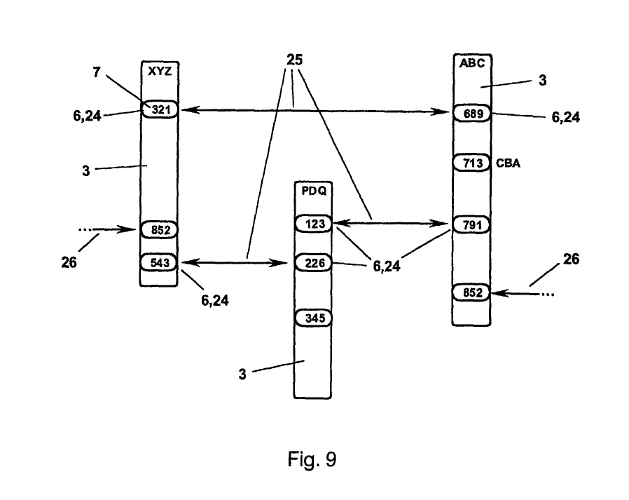

A single, large repository system can be assembled from a plurality of interconnected repositories. Each separate repository in the network manages its own set of repository stream entries, its own repository APIs, repository database, and file repository. Each repository manages its own resources and has its own server computer(s). The network of repositories may be multiply connected through Stream Connectors 24 (FIG. 9). Stream connectors are special stream entries that establish a connection between two separate streams and/or repositories. From a stream-centric point of view, the repository network simplifies to a network of interconnected streams.

FIG. 9 illustrates the preferred embodiment for a plurality of interconnected streams. Stream connections 24 join streams together, even distant streams 26. Each connection between streams is represented by a pair of reciprocally referencing stream entries like entry 321 in XYZ connected to entry 689 in ABC. Information or stream entries in one stream may be referenced from other streams through a ‘dot notation’ expression. For example, stream entry 713 in stream ABC may be referenced from stream PDQ with the following expressions:

713<==>123.713<==>226.321.713,

or if stream entry 713 is named CBA,

CBA<==>ABC.CBA<==>XYZ.ABC.CBA

The ‘dot notation’ is a relative path, from stream to stream, to the target stream entry. The dot notation may have any length needed to specify an entire path. Since the stream network can be multiply connected, there can be multiple valid paths to target stream entries.

The repository network makes it possible for multiple repositories to share information, or to mirror information to avoid bandwidth delays and latencies, or to protect information by holding it in several widely separated physical locations. The stream makes server-to-server transfers and synchronization of information easy.

### File Repository

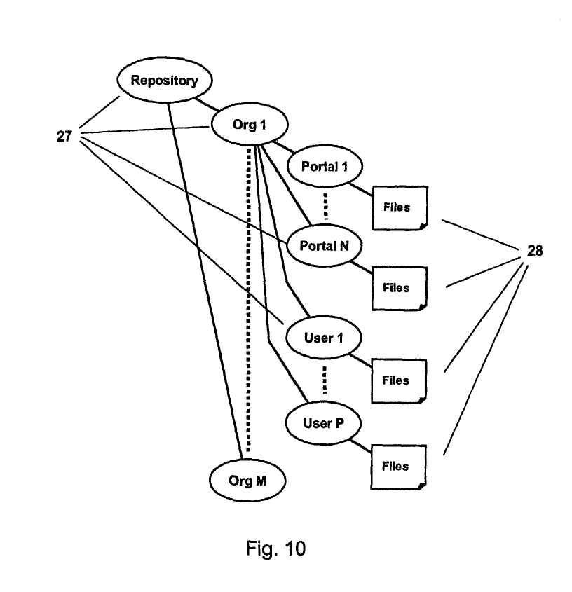

FIG. 10 illustrates the preferred embodiment for a File Repository. The file repository is intended to be a very simple structure for holding computer files that have been saved as content in the repository system. The file repository is a set of directories in the file system of the file server computer.

The directory at the top of the repository is called ‘Repository’. Under the repository directory are organization directories, one for each organization that's using this repository system. The organization directories are named ‘Org12345’, where the 12345 is the StreamID of the organization.

Below the organization directories are portal or workspace and user directories, one for each workspace and user in the organization. These directories are named ‘Portal12345’ and ‘User12345’ in just the same fashion as the organization directories.

The portal and user directories are the only ones that hold files. Each file has an entry in the stream that holds the full filepath+name for each file. Since the name of the file is maintained in the repository/stream, the filename in the file system could be a hash name for added simplicity/convenience and security.

### Additional Embodiments

Additional embodiments of the repository system can be made by modifying either the stream table or by adding or removing abstract data type tables according to the specific application. The modified repositories would be fully functional within the environment of the overall, larger repository system. Many of these modified repositories provide specific content to the entire repository environment.

An additional embodiment of the Stream Table is made by adding a text field to the end of the stream record. The text field may hold up to a specific number of characters (limit set by the specific database chosen) or may be an unlimited text blob field. This text field is called the EValue for historical reasons. This EValue makes it possible to save text data in the stream itself, making text available to single pass searching. In those situations where the EValue is limited in size, then the text is summarized or indexed, with the full text body being saved in a file ‘Text12345.txt’ (where 12345 is the StreamID) and the summary/index being saved in the text field.

A significant advantage of the EValue text field is that it enables an additional embodiment of the repository/stream to eliminate the Abstract Data Type tables. The data that would normally go into the ADT tables would be instead encoded/tagged in XML (Extensible Markup Language) and written to the EValue. XML is evolving as a data markup language to provide a standard mechanism for exchanging data between computers and applications. This approach with XML completely flattens the repository database, making everything in the database accessible to single pass searching, and making everything completely compatible with evolving open data standards.

An additional embodiment optimized to support Dictionary services would employ a special content table space with a modified stream table. Several of the stream table attribute groups would be removed, specifically the Date and Ownership groups; and special data types to support Dictionary information types would be created, like attributes for language, word roles (noun, verb, . . . ), and more. The stream based dictionary could be optimized to hold a plurality of language dictionaries or a plurality of special subject dictionaries. Dictionary types would include words, definitions, thesaurus, and cross links between words, and cross links between languages. Searches on words or word groups could produce specific dictionary tables for high performance spell checking in other repository databases.

An additional embodiment optimized to support Newspaper services would employ a special content table space with a modified stream table. The ownership attribute group could be removed and a Story Group substituted. The story group would contain large text fields to hold news story text, making news stories completely searchable. Special data types to support Newspaper information types would be created. A newspaper repository could hold hundreds of years of newspaper editions making it possible to do timeline searches for stories, articles, or advertisements according to specific themes or subjects. The newspaper repository could hold both new story text and images of the newspaper.

An additional embodiment implements a Software Management System (SMS) for running the development and delivery of software products. Loosely based on the portal system described in the operation section, the SMS modifies the stream table/record to deal with software specific metadata. The stream becomes a protected, version controlled, central repository for software artifacts including: usage scenarios, requirements, specifications, designs, documentation, test setups, code files, test results, and software configurations. The repository is a software library with full checkin/checkout able support remote development over the Web. Developers can sit anywhere in the world at the end of an internet connection. The SMS supports the software development process by keeping track of users/developers, status of development tasks, and holding metric data on accomplishment, schedules and cost. Project and software information is held in the repository/stream.

### Alternative Embodiments

The repository system uses commercial database products to implement the database schema, stream and abstract data type tables. Alternative embodiments may employ desktop database products that do not support tablespaces. In these embodiments, desktop database files would be used in place of the tablespaces, causing a plurality of database files being used for each of the system tablespace and the content tablespaces.

Another alternative embodiment would be to apply a desktop version of the respository system to enable peer-to-peer operation. In such an embodiment, users would synchronize their local repository/stream with the central repository/stream or synchronize directly with other users. This enables users to share information with each other and to work offline when disconnected from the internet.

Another alternate embodiment would be to implement the Repository APIs in Java/JSP, Server Side JavaScript, Perl, PHP, or any other web application development language. Alternate embodiments include implementations that run on any general purpose computer including, but not limited to: personal computers, workstations, mainframes, personal data assistants, etc. Client computers, computers that users employ to connect to such a repository system include: personal computers, workstations, mainframes, terminals connected some computer, personal data assistants (PDA), cell/internet telephones, web appliances, and more.

### Advantages

From the description above, a number of advantages of this repository system become evident, wherein a non-exhaustive list is provided below:

First, the Repository System simplifies information storage and management, and makes information easily accessible, searchable, and sharable. The repository's simplicity confers reliability and robustness, speedy performance, and ease of use. This repository system scales to handle a large number of users and very large volumes of information.

Second, the repository APIs simplify access to the repository database (specifically to the stream) and file repository. The APIs transparently manage information access, ownership, and protection issues. The APIs also handle information type and structure simplifying the search and retrieval of related data clusters.

Third, the Stream maintains a catalog of everything and data about everything saved in the repository. Everything in the repository system can be found by looking in the stream. This makes searching for any single item, or group of items, very simple using simple search parameters. The stream is easy to understand, easy to build, and easy to use.

Fourth, basic stream capabilities support complex information structures and clusters by combining a plurality of separate stream entries into dynamic constructs. The structure of these dynamic constructs is stored in the stream. Since the relationships between repository entries are saved in the stream, then anything connected to any structure can be retrieved by searching the stream.

Fifth, allowing customizations of the Stream while keeping Stream variations fully interoperable make it possible to optimize sections of the repository for special information/application needs.

Sixth, basic stream capabilities support easy management of information ownership and access rules. The stream record directly supports multiple levels of ownership and a full matrix of access rules and methods.

Seventh, the xMIME typing system supports information in files and databases. This makes it as easy to share information stored in databases as it is to share files. The xMIME typing system merges files, the repository database, and foreign databases into a unified information management system. The stream directly supports a more general information model (based on directed graph theory) than does the relational data model (based on set theory) implicit in relational databases. This makes it possible for the repository database to implement a very flat relational schema or architecture and push the complexity of information relationships into the stream, where it can be handled easier.

Eighth, the xMIME typing system is extensible, new types may be added whenever needed. The xMIME typing system enables the repository to handle the persistent data storage needs of programming languages. The repository database can accept and retrieve any data structure that any programming language can create.

Ninth, the xMIME typing system combined with the directed graph theory approach makes it possible to dismantle and flatten legacy databases. Indexing or copying foreign database records into the stream, more complex, complete, accurate information models may be constructed that can yield superior knowledge results. With the addition of interface tools to read information from legacy databases, the repository/stream could be used to integrate information across a broad set of legacy systems, and deliver that integrated information, racked and stacked, and digested for desemination.

### Operation of Invention

The preferred and alternative embodiments of repository systems described herein were developed to manage information for an advantageous portal system. The basic objects were to provide a system that is simple to use, reliable, and secure, and that supports the development and delivery/operation of information-driven, web-based services. FIG. 1 illustrates the relationship between these services and the repository. The collected set of services and the repository (its parts and interfaces) constitutes an advantageous portal system in accordance with a preferred embodiment herein.

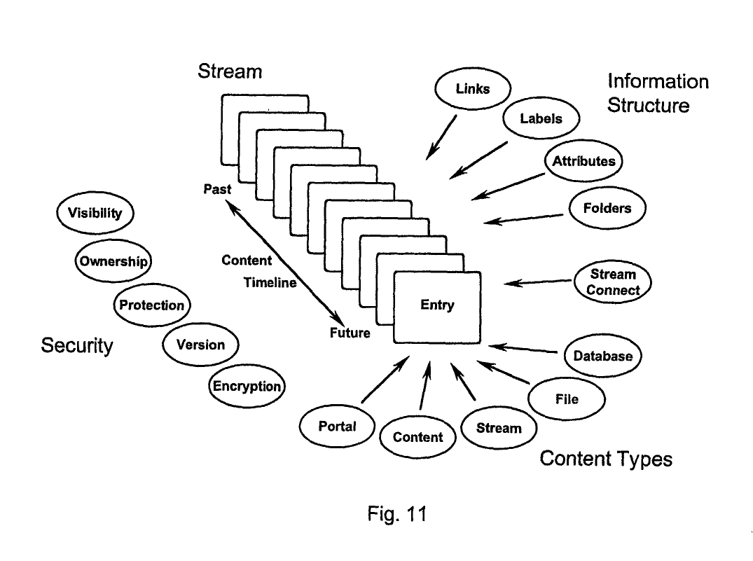

The repository invention is a set of basic tools and structures from which to construct an information management system. FIG. 11 details the basic features of the repository. The features fall into 4 main feature sets: the stream, security, content types, and information structure. The stream is the foundation that holds data about information stored in the repository. The stream is organized as a timeline list, where new entries are added to the system daily, in a non-ending stream, stretching from the past to the present, and on into the future. The stream flows forward daily with new content.

Security features control the visibility, ownership, protection, version, and encryption of information in the stream. Content types describe the type of each stream entry using the xMIME typing system that is part of this invention. The xMIME type tells whether a stream entry is a file or a database record, a part of the system itself or user content; its general type (text, numeric, . . . ) and specific type.

Information structure features manage the assembly of information in the form of stream entries into higher level constructs, clusters, and structures. These constructs are object-like and highly dynamic, meaning that they can change in content and form at the whim of the system and users.

To best illustrate the operation of the preferred embodiment of the repository system, the following describes the assembly and operation of a portal repository using this present repository invention.

### What is a Portal?

Portals according to preferred embodiments herein are private workspaces on the Web where members may go to share information, to interact with one another, and to work and play together. Members may save, upload, view, edit, change, move, interact with-, and download information, files, and data from portals to which they have access. Organizations use portals to better communicate and serve their stakeholders: members, employees, partners, clients, investors, vendors, and customers. The only technical requirement is that portal members must use a standard web browser to interact with portal services.

The basic concept is that members enter their portal from the internet through an authentication process, then interact with services that connect to information residing in the portal repository. The authentication process protects members' information and insures privacy.

Portals are gateways to information stored in the portal repository. Portals compartmentalize information into separate access controlled workspaces. Each portal workspace has attached services that enable authorized users to interact with information saved in the portal, and with other users that are logged-in to the same portal. Different portal workspaces may have different sets of services, making it possible to configure different workspaces for different purposes.

### Next, Build a Portal System

Building a portal system begins with the portal repository. Building the portal repository begins with the repository database schema. And defining the repository schema begins with designing the stream table, the central, most important component of the entire repository. From there, the admin data types must be defined, followed by the basic attribute types and service types. Then initial records must be defined and loaded into the database to breath life into the new portal installation.

The listing shown in Tables 1.1-4.2, below, includes a complete specification of the basic repository and portal components, the abstract data types, and resulting database tables. First, the stream components are defined. The stream components include the stream table, xMIME types definition, the stream identifier and connector, then links, labels, and folders. Many defined types do not require nor have associated database tables; these type are implemented entirely in the stream. Variations in the stream table definition may require modification to the underlying standard general stream APIs.

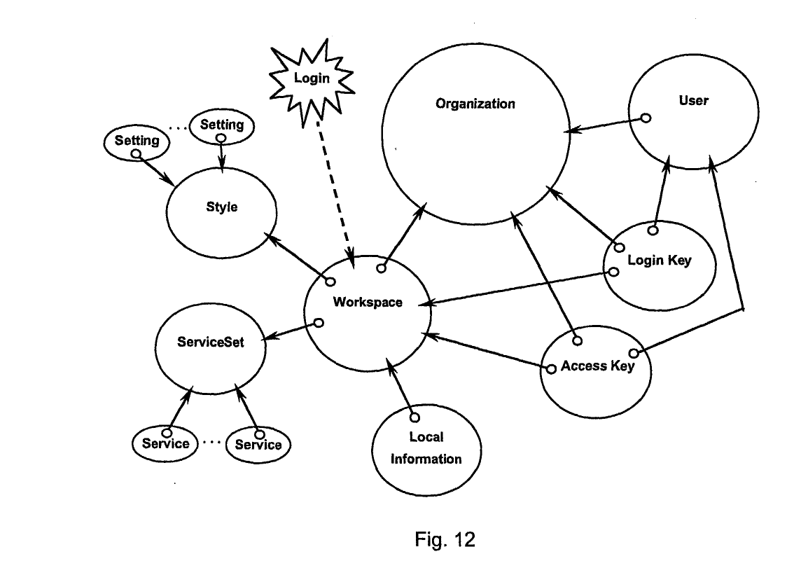

Next, FIG. 12 shows the major components, plus their relationships, that make up a portal. The specification in Tables 1.1-4.2 shows the definition of the portal admin components. These include organizations, persons, workspaces, login keys, access keys, service sets, services, and styles. Style attributes are defined in the attributes section in the specification. The basic attributes required to support styles include text, numeric, color, and image. These components are also abstract data types.

Finally, service types are defined. These types specify data types that support service operations. Two service type examples, Messages and Events, are included in specification listed in Tables 1.1-4.2. The service software calls the standard general stream APIs to interact with the repository database.

Next the specification listing in Tables 1.1-4.2 is converted to a pair of SQL scripts: a creation script and an install script. These scripts assume the availability of the necessary portal service software that operates a portal system.

The install script loads a minimal set of data records into the database that is required to bring the system to life. The repository-stream-portal will not run without these data records. These data records are the embodiment of the running system. These records contain data, specify files, specify at least one organization, one user, one workspace, and one login key. Once the system is running, then the installing administrator can login and complete setting up the system by adding more users and workspaces, create service sets and styles, and give out login keys.

Once the tables defined in this document are created, then a cluster of data records/stream entries must be placed in the new tables to kickstart the repository system. Putting together a proper set of stream entries can be like putting together a jigsaw puzzle, exactly the right pieces must be put together in the correct configuration to complete the picture. Bringing up a new repository is the same.

### Stream Table

The stream table is the backbone of the repository, providing the main metadata catalog/list to which abstract data type tables and supporting tables are joined.

TABLE 1.1
REPOSITORY STREAM TABLE
Stream Metadata Table:

| | | |
|---|---|---|
| 1. StreamID | AutoNumber | Unique Stream ID Number |
| | Long | |
| 2. CreateDate | Date/Time | Creation Date |
| 3. ChangeDate | Date/Time | Last Change Date |
| 4. BeginDate | Date/Time | Begin Date |
| 5. EndDate | Date/Time | End Date |
| 6. OrgID | Number Long | Organization Stream ID Number |
| 7. WorkSpaceID | Number Long | Workspace Stream ID Number |
| 8. OwnerID | Number Long | Owner Stream ID Number |
| 9. AuthorID | Number Long | Author Stream ID Number |
| 10. SLinkID | Number Long | Strong Link Stream ID |
| 11. WLinkID | Number Long | Weak Link Stream ID |
| 12. AccessLevel | Number Byte | 0 = none,1 = SuperAdmin, |
| | | 2 = Admin, |
| 13. Protect | Number Byte | 0 = Private, 1 = Read, 2 = Write |
| 14. Context | Number Byte | 0 = none, 1 = Open, 2 = Common, |
| | | 3 = Publish |
| 15. Enabled | Number Byte | 0 = Enabled, 1 = Admin Disabled, |
| | | 2 = SuperAdmin Disabled |
| 16. LockID | Number Long | 0 = UnLocked, |
| | | User StreamID w/lock = Locked |
| 17. Archive | Boolean | 0 = not archived, 1 = archived |
| 18. EDelete | Boolean | Entry Delete: 0 = not, 1 = deleted |
| 19. Version | Number Long | 0 = No Version Control, |
| | | # = Current Version Number. |
| | | # = Previous Version Number |
| 20. TCount | Number Long | Total Use Count |
| 21. RCount | Number Long | Recent Use Count |
| 22. LSize | Number Long | Stream Entry Size in bytes |
| 23. RSize | Number Long | Item Size in bytes |
| 24. GeneralClass | Text 250c | Component Type Identifier |
| 25. StorageClass | Text 250c | Storage Class Type Identifier |
| 26. GeneralType | Text 250c | General Type Identifier |
| 27. SpecificType | Text 250c | Specific Type Identifier |
| 28. Location | Text 1024c | Location Reference Path |
| 29. Name | Text 1024c | Name or Title |

TABLE 1.2
xMIME TYPE DATA TYPE
Type: type/.../.../...

Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 9. AuthorID | Number Long | Author's Stream ID |
| 24. GeneralClass | Text 50c | type |
| 25. StorageClass | Text 50c | = stream, file, database |
| 26. GeneralType | Text 50c | = ... |
| 27. SpecificType | Text 50c | = ... |
| 29. Name | Text 250c | Type Table or Extension List |

xMIME Data Type Table:

An xMIME data type table is not required. xMIME data lives entirely in the stream. The entire collection of standard MIME types is in the stream under type/file class keywords.

TABLE 1.3
STREAM IDENTIFIER DATA TYPE
Type: portal/stream/stream/stream

Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 9. AuthorID | Number Long | Author's Stream ID |
| 24. GeneralClass | Text 50c | = portal |
| 25. StorageClass | Text 50c | = stream |
| 26. GeneralType | Text 50c | = stream |
| 27. SpecificType | Text 50c | = stream |
| 29. Name | Text 250c | Stream Name |

Stream Identifier Data Type Table:

| | | |
|---|---|---|
| 1. StreamID | Number | Same Stream ID Number |
| 2. DataSource | Text 250c | Data Source (Which Database) |
| 3. Username | Text 250c | Database User Name |
| 4. Password | Text 250c | Database Password |
| 5. StreamURL | Text 250c | Stream URL Path |
| 6. StreamPath | Text 250c | Stream Directory Path |
| 7. FileURL | Text 250c | File Repository URL Path |
| 8. FilePath | Text 250c | File Repository Directory Path |

A Stream Identifier record is preferably the first record saved into a new stream. StreamID=1 is the stream's identifier record.

TABLE 1.4
STREAM CONNECTOR DATA TYPE

| Type: portal/stream/stream/connector | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 9. AuthorID | Number Long | Author's Stream ID |
| 24. GeneralClass | Text 50c | = portal |
| 25. StorageClass | Text 50c | = stream |
| 26. GeneralType | Text 50c | = stream |
| 27. SpecificType | Text 50c | = connector |
| 29. Location | Text 250c | Foreign Stream URL |
| 29. Name | Text 250c | Foreign Stream Name |

Stream Connector Data Type Table:

A Stream Connector data type table is not required. Accessing another repository through the stream connector performs an implicit authorization process before the foreign repository responds.

TABLE 1.5
LINK DATA TYPE
Type: .../stream/stream/Iink

Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkspaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralClass | Text 50c | = ... |
| 25. StorageClass | Text 50c | = stream |
| 26. GeneralType | Text 50c | = stream |
| 27. SpecificType | Text 50c | = link |
| 29. Name | Text 250c | Link Name |

Link Data Type Table:

| | | |
|---|---|---|
| 1. StreamID | Number Long | Same or Source Stream ID Number |
| 2. TargetID | Number Long | Target Stream ID Number |

TABLE 1.6
LABEL DATA TYPE
Type: .../stream/stream/label

Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkspaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralClass | Text 50c | = ... |
| 25. StorageClass | Text 50c | = stream |
| 26. GeneralType | Text 50c | = stream |
| 27. SpecificType | Text 50c | = label |
| 29. Name | Text 250c | Label Name |

Label Data Type Table:

The label data type uses the link data type table.

TABLE 1.7
FOLDER DATA TYPE
Type: .../stream/stream/folder

Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkspaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralCLass | Text 50c | = ... |
| 25. StorageClass | Text 50c | = stream |
| 26. GeneralType | Text 50c | = stream |
| 27. SpecificType | Text 50c | = folder |
| 29. Name | Text 250c | Folder Name |

Folder Data Type Table:

The folder data type uses the link data type table.

TABLE 2.0
ADMIN DATA TYPES

Portal admin data types are abstract data types.

Most types have abstract data type tables, while
some do not. These data types implement the basic
data types required to build portals.

TABLE 2.1
ORGANIZATION DATA TYPE
Type: portal/stream/admin/organization

Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 9. AuthorID | Number Long | Author's Stream ID |
| 24. GeneralCiass | Text 50C | = portal |
| 25. StorageClass | Text 50c | = stream |
| 26. GeneralType | Text 50c | = admin |
| 27. SpecificType | Text 50c | = organization |
| 29. Name | Text 250c | Organization's Name |

Organization Data Type Table:

| | | |
|---|---|---|
| 1. StreamID | Number | Same Stream ID Number |
| 3. UserLimit | Number | User Number Limit |
| 4. WorkspaceLimit | Number | Workspace Number Limit |
| 5. AdminPortalID | Number | Admin Portal ID Number |
| 6. StartPortalID | Number | Start Portal ID Number |
| 7. FilePath | Text 250c | Repository Directory Path |
| 8. URLPath | Text 250c | Repository URL Path |

TABLE 2.2
PERSON DATA TYPE

| Type: portal/stream/admin/person | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = user |
| 29. Name | Text 250c | Person's Full Name |
| 1. StreamID | Number | Same Stream ID Number |
| 3. Prefix | Text 20c | Honorarium Prefix |
| 4. FirstName | Text 30c | First Name |
| 5. LastName | Text 50c | Last Name |
| 6. MiddleName | Text 50c | Middle Name |
| 7. Suffix | Text 20c | Honorarium Suffix |
| 8. Profession | Text 50c | Profession Label |
| 9. FilePath | Text 250c | Repository Directory Path |
| 10. URLPath | Text 250c | Repository URL Path |

Person Data Type Table:

TABLE 2.3
WORKSPACE DATA TYPE

Type: portal/stream/admin/workspace
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = workspace |
| 29. Name | Text 250c | Workspace Name |

Workspace Data Type Table:

| | | |
|---|---|---|
| 1. StreamID | Number | Same Stream ID Number |
| 2. ServiceSetID | Number | ServiceSet Stream ID Number |
| 3. StyleID | Number | Style Stream ID Number |
| 4. FilePath | Text 250c | Repository Directory Path |
| 5. URLPath | Text 250c | Repository URL Path |

TABLE 2.4
LOGINKEY DATA TYPE

Type: portal/stream/admin/loginkey
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = loginkey |
| 29. Name | Text 250c | Workspace/User Name |

LoginKey Data Type Table:

| | | |
|---|---|---|
| 1. Stream ID | Number | Same Stream ID Number |
| 2. AccessLevel | Number Byte | 0 = none, 1 = SuperAdmin, |
| | | 2 = Admin, 3 = User, 4 = Viewer |
| 3. LoginName | Text 20c | Login Name |
| 4. Password | Text 20c | Password |
| 5. Reminder | Text 100c | Reminder Text |

TABLE 2.5
ACCESSKEY DATA TYPE

| Type: portal/stream/admin/accesskey | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = accesskey |
| 29. Name | Text 250c | Workspace/User Name |

AccessKey Data Type Table:

An AccessKey data type table is not required. AccessKeys live entirely in the stream.

TABLE 2.6
SERVICE SET DATA TYPE

| Type: portal/stream/admin/serviceset | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 6. OrgID | Number Long | Organization's Stream ID |
| 7. WorkSpaceID | Number Long | Workspace's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = serviceset |
| 29. Name | Text 250c | ServiceSet Name |

ServiceSet Data Type Table:

A ServiceSet data type table is not required. ServiceSets live entirely in the stream.

TABLE 2.7
SERVICE DATA TYPE

Type: portal/stream/admin/service
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 6. OrgID | Number Long | Organization's Stream ID |
| 7. WorkSpaceID | Number Long | Workspace's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = service |
| 29. Name | Text 250c | Service Name |

Service Data Type Table:

| | | |
|---|---|---|
| 1. StreamID | Number | Same Stream ID Number |
| 2. ServiceURL | Text 250c | Service URL |
| 3. ServiceTarget | Number | 0 = Display, 1 = Top, |
| | | 2 = New, 3 = PopUp |
| 4. NavOrder | Number | Order in Nav Button Stack |
| 5. AccessLevel | Number Byte | 0 = none, 1 = SuperAdmin, |
| | | 2 = Admin, 3 = User, 4 = Viewer |
| 6. ButtonOption | Number | 0 = Text, 1 = Image, 2 = Rollover |
| 7. Button1 | Text 250c | Top Button Image |
| 8. Button2 | Text 250c | Rollover Button Image |
| 9. BWidth | Number | Button Image Width |
| 10. BHeight | Number | Button Image Height |
| 11. BlankHeight | Number | Following Blank Space Height |

TABLE 2.8
STYLE DATA TYPE

| Type: portal/stream/admin/style | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 24. GeneralClass | Text 50c | = portal |
| 25. StorageClass | Text 50c | = stream |
| 26. GeneralType | Text 50c | = admin |
| 27. SpecificType | Text 50c | = accesskey |
| 29. Name | Text 250c | Style Name |

Style Data Type Table:

A Style data type table is not required. Styles live entirely in the stream. Style settings are Attribute Data items that are of class portal/stream or portal/file.

TABLE 3.0
ATTRIBUTE DATA TYPES

Attribute data types are abstract data types. Most of these types have
abstract data type tables, while some do not. These data types include
attribute data types that support portal components and user content.

TABLE 3.1
TEXT DATA TYPE

Type: . . . /stream/text/plain
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. End Date | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralClass | Text 50c | = portal, content, or . . . |
| 25. StorageClass | Text 50c | = stream |
| 26. GeneralType | Text 50c | = text |
| 27. SpecificType | Text 50c | = text |
| 29. Name | Text 250c | Text Attribute Name |

Text Data Type Table:

| | | |
|---|---|---|
| 1. StreamID | Number | Same Stream ID Number |
| 2. EValue | Text 4000c | Text Attribute Value |

The text data type is reused by several other data types. The text attribute data type is often associate with a text file that is saved in the file repository to deal with the situation when the amount of text to be saved is greater than 4000 characters. The first 4000 characters are written to the EValue text field, then the entire piece of text is written to a text file with the name ‘SpecificTypeStreamID.txt’. Some examples are ‘Text2345.txt’ or ‘Note4321.txt’ or ‘Message6543.txt’.

TABLE 3.2
NUMERIC DATA TYPE

Type: . . . /stream/numeric/numeric
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralClass | Text 50c | = portal, content, or . . . |
| 25. StorageClass | Text 50c | = stream |
| 26. GeneralType | Text 50c | = numeric |
| 27. SpecificType | Text 50c | = numeric |
| 29. Name | Text 250c | Numeric Attribute Name |

Numeric Data Type Table:

| | | |
|---|---|---|
| 1. StreamID | Number | Same Stream ID Number |
| 2. EValue | Number Long | Numeric Attribute Value |

TABLE 3.3
COLOR DATA TYPE

Type: . . . /stream/color/hexcolor
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralClass | Text 50c | = portal, content, or . . . |
| 25. StorageClass | Text 50c | = stream |
| 26. GeneralType | Text 50c | = color |
| 27. SpecificType | Text 50c | = hexcolor |
| 29. Name | Text 250c | Color Attribute Name |

Color Data Type Table:

| | | |
|---|---|---|
| 1. StreamID | Number | Same Stream ID Number |
| 2. EValue | Text 6c | Color Attribute Value |

TABLE 3.4
IMAGE DATA TYPE

Type: .../file/image/gif, .../file/image/jpg, or .../file/image/png
Relevant Stream Fields:

| | | |
|---|---|---|
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 10. SLinkID | Number Long | Strong Binding Link Stream ID |
| 11. WLinkID | Number Long | Weak Binding Link Stream ID |
| 24. GeneralClass | Text 50c | = portal, content, or ... |
| 25. StorageClass | Text 50c | = file |
| 26. GeneralType | Text 50c | = image |
| 27. SpecificType | Text 50c | = gif, jpg, or png |
| 28. Location | Text 250c | File Path/File Name |
| 29. Name | Text 250c | Image Attribute Name |

Image Data Type Table:

An Image data type table is not required. Images are files and do not have data type tables. Images are stored in the file repository.

TABLE 4.0
SERVICE DATA TYPES
Service data types are abstract data types and directly support
portal services.

TABLE 4.1
MESSAGE DATA TYPE

| Type: content/stream/text/message | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 24. GeneralClass | Text 50c | = content |
| 25. StorageClass | Text 50c | = stream |
| 26. GeneralType | Text 50c | = text |
| 27. SpecificType | Text 50c | = message |
| 29. Name | Text 250c | Message Title |

Message Data Type Table:

The message data type uses the text attribute table to save the message body text.

TABLE 4.2
EVENT DATA TYPE

| Type: content/stream/text/event | | |
|---|---|---|
| Relevant Stream Fields: | | |
| 1. StreamID | Number | Unique Stream ID Number |
| 2. CreateDate | Date/Time | Creation Date |
| 3. ChangeDate | Date/Time | Change Date |
| 4. BeginDate | Date/Time | Starting Date |
| 5. EndDate | Date/Time | Expiration Date |
| 6. OrgID | Number Long | Organization's Stream ID |
| 7. WorkSpaceID | Number Long | Workspace's Stream ID |
| 8. OwnerID | Number Long | Owner's Stream ID |
| 9. AuthorID | Number Long | Author's Stream ID |
| 24. GeneralClass | Text 50c | = content |
| 25. StorageClass | Text 50c | = stream |
| 26. GeneralType | Text 50c | = text |
| 27. SpecificType | Text 50c | = message |
| 28. Location | Text 250c | Event Location |
| 29. Name | Text 250c | Event Title |

Event Data Type Table:

The event data type uses the text attribute table to save the event description text.

### Updating the Standard General Stream API (SGSAPI)

This embodiment of the standard general stream API is written in a combination of CFML (Cold Fusion Markup Language) and SQL. CFML runs on the Cold Fusion Application Server which connects to a web server on the front end and to a database server on the back end.

One embodiment of the SGSAPI is in both CFML and SQL. This single API implements is capable of implementing each of the nine standard methods or functions listed above. Each Abstract Data Type (described below) preferably uses an API module which will be a variation on the SGSAPI.

### The Login-authentication Process

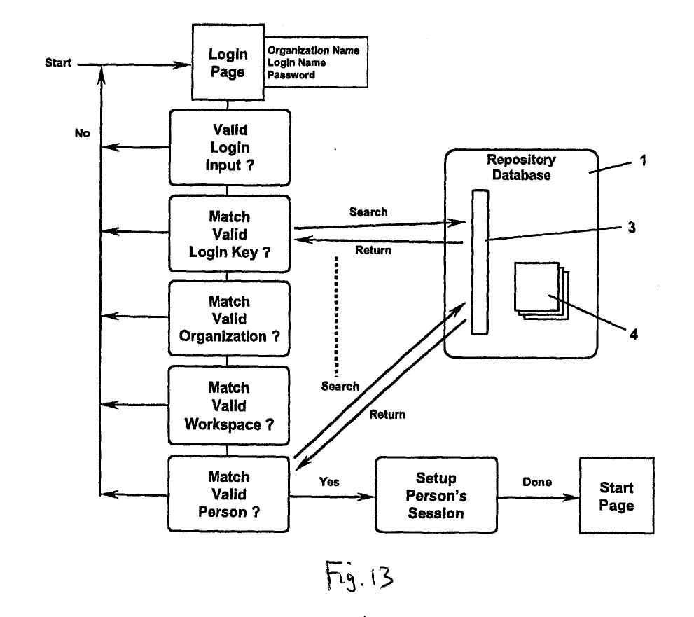

An excellent sense how the repository system works is to examine the login process. FIG. 13 illustrates the login-authentication process. At the login page the user enters their organization name, login name, and password. The first step in the login process is to error check the user's login input. Next, at the ‘Match Valid Login Key’ step, the login process queries the stream in the repository database for a login key that matches the user's login input. If found, login key parameters are evaluated for current validity, and if valid the process continues with the next step, otherwise the user is returned to the login page.

At each following step, additional data is requested from the stream and is validated against the user's status. If the validation checks are passed, then the user's session is established and the user is transferred to the portal start page. Nearly every other process carries out a dialog with the stream to search, examine, and perhaps update existing information or add new information.

### The Portal Interface and a Simple Service

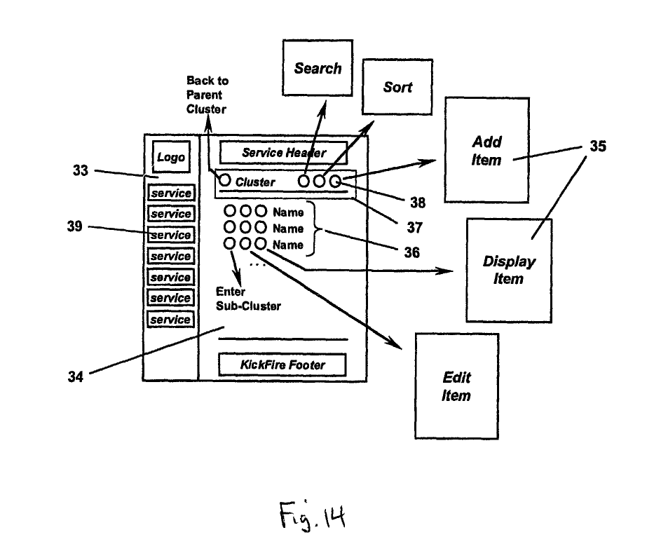

FIG. 14 illustrates a user interface concept for the portal/repository system as it would be displayed in the user's browser. This interface presents a structural view of information. The main parts are the left vertical Navigation Bar 33, the right Display Page 34, and the plurality of popup sub-windows 35. Operationally, the user would click a service button on the Nav Bar to bring up the service main display in the Display Page. The service main page has a header, footer, a control strip 37, and a page body. The page body serves up a list 36 of service-specific items from the repository/stream. There are several icon buttons associated with each of the items in the list.

The user single-clicks on the icon buttons to navigate about the display page. Most of the icons bring up a popup sub-window that variously provide service pages for searching and sorting the page body list, or for adding a new item to the list, or editing or displaying an item from the list. If any item in the list represents a cluster of items, then, by single-clicking the appropriate icon, the list of items in the cluster can be brought up into the main service display. The leftmost icon in the control strip takes the user back to the previous list.

Behind the interface, the HTML service pages are generated by the service software. The portal service software runs in an application server which runs on a server computer and manages the dialog between the client and the server. The portal service software generates the HTML file that creates the user interface on the user's browser. The HTML file is a program that is written by the service module. The portal service is composed from Cold Fusion Markup Language, SQL, HTML, and client-side JavaScript. The generated HTML user interface file is composed from HTML and client-side JavaScript.

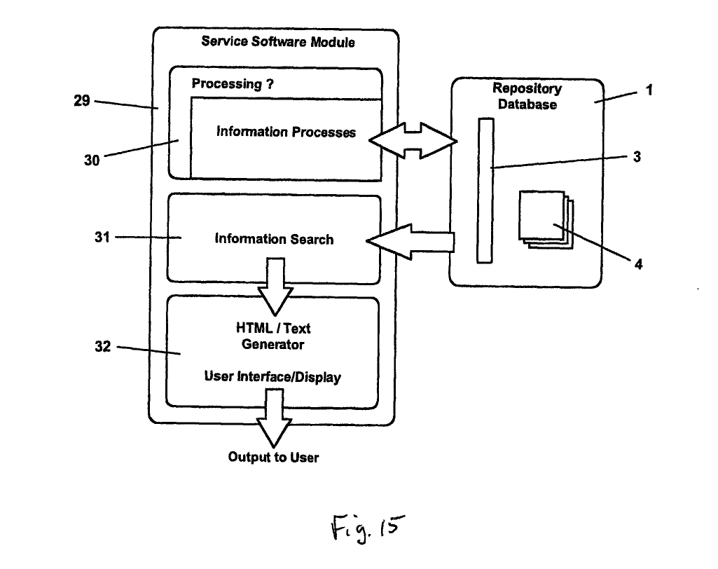

FIG. 15 illustrates the basic service software structure. The basic service module has three main parts: Stream Processing, Stream Search, and the HTML Generator. The stream processing block handles adding, updating, or deleting entries in the stream. The stream processing block is optional, not every service module changes items in the stream. The search block retrieves information from the stream and passes it to the HTML Generator block.

The HTML Generator takes the retrieved information and generates an HTML interface page to be sent to the user's browser. The user interface page in the display frame 34 (FIG. 15) and each of the pages in the sub-windows 35 (FIG. 15) are generated by a separate service module.

The generated HTML pages are designed to call their parent service modules to handle any processing requested by the user. A service module that is associated with a sub-window, when called by its interface, will make stream updates then send down a new, refreshed interface page. Upon receipt by the browser, the page may send a callback to the parent display frame to tell it to refresh itself to respond to updates.

### The Structure of Information

For the purposes of this patent disclosure, the term ‘information’ is defined to include files stored in computer file systems and data records saved in computer databases. Files include all manner of computer documents holding any kind of data including for example, but not limited to, text, images, structured data (such as spreadsheets and the like), and entire databases (that are saved in files). Computer files can and may hold software code, from any arbitrary programming language, in plain or formatted text form. Database data records include for example, but not limited to, text, numeric data, dates, currency, and other data. Database data records may be simple or may have complex data-record structures. The repository can hold and manage any type of information that can be put into a file or into a database record.

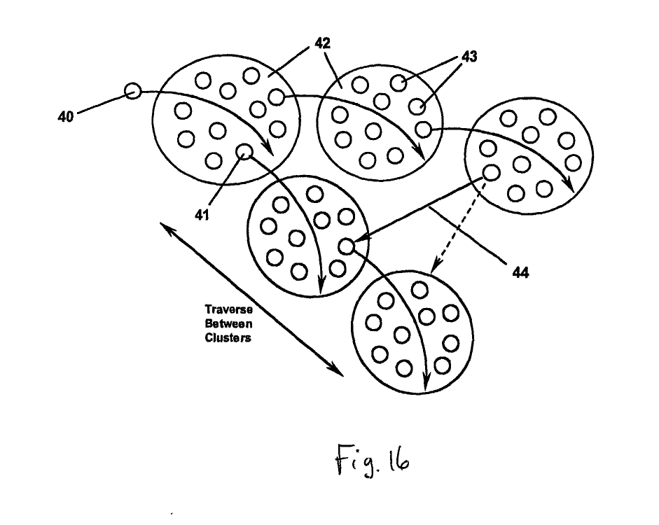

FIG. 16 illustrates a basic information structural model that is the foundation for the preferred embodiment of the repository system. This information model is based on directed graph theory, wherein information is organized into networks of clusters based on context. This model was chosen because it reflects how people naturally organize information. People organize information into linked clusters and clusters of clusters. Everyone's clusters are somewhat different, but the organizational method is the same. This organization method reflects the basic structure of information.

Accordingly, the repository system enables information to be organized into a network of context clusters. FIG. 16 shows the root of a cluster tree 40, which identifies the cluster tree, the cluster 42 itself is its own embodiment and context. Clusters can hold attributes and atomic data items 43, hold sub-clusters 41, and clusters may be cross linked 44 with other clusters. Clusters are dynamic and may change and be rearranged over time.

Each user can organize information how they wish without impacting other users. Users can share and organize the same information into their own different clusters without conflict, or they can create and share common information clusters. For example two people looking at the same car may construct very different context clusters. One person may look at the car with engine, body, passenger compartment, and trunk sub-clusters. They might further subdivide according to car parts. The other person may only see the car as a passenger compartment and a trunk, and then subdivide those based on the potential passengers or the stuff being transported.

### Conclusions, Ramification, and Scope of Invention

An information repository system that is accessed via internet/web is described above in which:

1. a repository system that stores and protects members' information;

2. members' information may be made available 24 hours/day, 365 days/year, in perpetuity;

3. the repository merges files and databases into a single storage environment;

4. the repository uses a metadata stream to manage everything stored in the portal repository;

5. the metadata stream uses linking and clustering to enable portal members to organize shared information;

6. the metadata stream extends the open Multipart Internet Mail Extension (MIME) typing grammar to include records in database tables;

7. the metadata stream implements abstract data types using a flat dynamic/sparse table architecture;

8. the repository supports multiple, separate, interconnected metadata streams for performance, security, and context.

9. methods for collecting and managing data on system resource utilization by members with/from which to build itself. This is a new software development paradigm.

Beyond re-implementing the repository system in different programming language, using different software server components, different databases or file systems, of different computer systems; the principal repository system variations revolve around the stream table and repository support tables. For example:

First, stream links, labels, attributes, and folders can be implemented with simple link table that connects stream entries to each other. If the item linked is a label then the link is a label link. The others work preferably the same way. This takes links outside the stream, and slightly complicates SQL queries, but it may make improve performance.

Second, the Stream Table is a focal point for variation. The stream table holds specific groups of metadata and different repository applications may require different metadata. Accordingly, the stream table would be modified to change out some metadata groups for new ones.

Third, the xMIME system is another focal point for variation. Variation is not in the design or implementation of the xMIME type system but in the utilization of the xMIME system. New xMIME types can be defined and any time for any purpose and the expression of these new types may cause the repository to generate new abstract data type tables.

Fourth, another extension of the xMIME typing system would be to apply xMIME types to the internal structure of files. This would create a set of specific file-internals xMIME types. In addition, this creates a connection between xMIME types and the Extend Markup Language (XML) that is often used to markup data content. xMIME types could be defined by and denote specific XML tag structures. An XML Document Type Definition (DTD) could be written to associate specific xMIME types to specific XML tags.

Fifth, another variation of the xMIME system would look into the internals of software applications and apply xMIME typing to functional application components. This could begin to apply typing relationships between software functions, to begin to automate the assembly of functions into applications.

### Ramifications of this Invention

The repository places preferably of the structure of information in the stream table. Entries in the stream table denote the existence of information resources. Metadata in the stream table describe information resources and information relationships, both of which may be, and preferably are, stored as entries in the stream table. Information relationships, of any sort, may be stored as relationship links in the stream table. Information and the structure of information may be recorded in the stream table. Information resources may be located anywhere and may reside in any file system or in any database.

An important ramification is that the repository stream enables information living in diverse sources to be integrated into a single, unified information management system. This enables new relationships to be forged between information and information sources that were isolated from one another. Every bit of information in each information source can be indexed, typed, and annotated in the stream. New, stream-based information constructs are possible, and new stream-borne conclusions will be realized.

The repository stream enables disparate, diverse, isolated information sources to be integrated into a unified whole. Many examples of the application of such a repository system include:

### Health Care

Integrating diverse information from patient records, treatments, drugs, hospital information, diseases and medical conditions, and more would greatly improve the efficient delivery of medical service and accelerate medical research.

### Human Genome Research

The entire human genome sequence plus individual variations could be loaded in the repository stream. The nucleotide sequence in the stream could be linked into genes, genes into chromosomes, including variations, and annotated with researcher's notes and tied to medical data.

### Police Data Management

Police departments around the country have large sets of data on criminals, crimes, finger prints, etc. that is difficult to share in any coordinated way. Loading and tagging that data into a repository stream would make it possible to assemble and retrieve data to solve crimes, reports crime statistics, and perhaps to detect and deal with crime trends.

### Education

Student information, registration, instructional materials, books, class notes, and more could be put into a repository stream system to enable distance learning, to enhance both the learning and teaching experience. Could help manage schools and colleges and perhaps the entire educational system.

### Project Management

Project information including: goals, objectives, schedule, cost, tasks, status information, plans, designs, drawings, etc., would be loaded in the repository stream system from diverse sources and by geographically separated project participants, like an international construction project, to improve the efficiency of large projects.

### Publishing

The repository stream system could support a large newspaper/magazine/book/library publishing system where authors would create literary, new, informational content that would be saved and organized in the stream. The content would be organized to make it easy for readers and users to find and view the content for free or for a fee. This application could include features like a World Wide Want Ads, world and local news, and articles of interest are organized and segmented for access by readers and users.

While the above description contains many specifications, these should not be construed as limitations on the scope of the invention, but rather as an exemplification of one preferred embodiment thereof. Many other variations are possible. Accordingly, the scope of the invention should be determined not by the embodiment(s) illustrated, but by the appended claims and their legal equivalents.

In addition, in the method claims that follow, the steps have been ordered in selected typographical sequences. However, the sequences have been selected and so ordered for typographical convenience and are not intended to imply any particular order for performing the steps.

What is claimed is:

1. A data repository portal running on one or more computers for managing information, comprising:
a set of repository API's for interfacing the repository with a computer network;
a file repository containing file data; and
a repository database including a stream table having entries for said file data and for database data, such that said file data and said database data are managed within a same data storage environment.

2. The data repository of claim 1, wherein said stream table further includes at least one stream connector entry for establishing a connection with another repository database.

3. A data repository running on one or more computers for managing information, comprising:
a set of repository API's for interfacing the repository with a computer network;
a file repository containing file data; and
a repository database including a stream table having entries for said file data and for database data, wherein said stream entries for said file data and for said database data are indexed according to an extended MIME typing that includes a storage class, along with a general type and a specific type, for distinctly typing said file data and said database data within a same data storage environment.

4. The data repository of claim 3, wherein said extended MIME typing, according to which said stream entries are indexed according to, further includes a general class for distinctly classifying kinds of content within said same data storage environment.

5. The data repository of claim 3, wherein said stream table further includes at least one stream connector entry for establishing a connection with another repository database.

6. A data repository running on one or more computers for managing information, comprising:
a set of repository API's for interfacing the repository with a computer network;
a file repository containing file data; and
a repository database including a stream table having entries for said file data and for database data, wherein said stream entries for said file data and for said database data are indexed according to an extended MIME typing that includes a general class, along with a general type and a specific type, for distinctly classifying kinds of content within a same data storage environment.

7. The data repository of claim 6, wherein said stream table further includes at least one stream connector entry for establishing a connection with another repository database.

8. A repository database stored on one or more computers, comprising a stream table having entries for file data and for database data, such that said file data and said database data are managed within a same data storage environment.

9. The repository database of claim 8, wherein said stream table further includes at least one stream connector entry for establishing a connection with another repository database.

10. A repository database stored on one or more computers, comprising a stream table having entries for file data and for database data, wherein said stream entries for said file data and for said database data are indexed according to an extended MIME typing that includes a storage class, along with a general type and a specific type, for distinctly typing said file data and said database data within a same data storage environment.

11. The repository database of claim 10, wherein said extended MIME typing further includes a general class for distinctly classifying kinds of content within said same data storage environment.

12. The repository database of claim 10, wherein said stream table further includes at least one stream connector entry for establishing a connection with another repository database.

13. A repository database stored on one or more computers, comprising a stream table having entries for file data and for database data, wherein said stream entries for said file data and for said database data are indexed according to an extended MIME typing that includes a general class, along with a general type and a specific type, for distinctly classifying kinds of content within a same data storage environment.

14. The repository database of claim 13, wherein said stream table further includes at least one stream connector entry for establishing a connection with another repository database.

15. A repository database stored on one or more computers, comprising a stream table having entries for managing data within a data storage environment including at least one other repository database, wherein said repository databases within said data storage environment have stream connector entries for establishing a connection between said repository databases.

16. A repository database stored on one or more computers, comprising a stream table having entries for managing data within a data storage environment that are indexed according to an extended MIME typing that includes a storage class, along with a general type and a specific type, and wherein said data storage environment includes at least one additional repository database, and wherein said repository databases within said data storage environment have stream connector entries for establishing a connection between said repository databases.

17. The repository database of claim 16, wherein said extended MIME typing further includes a general class.

18. A repository database stored on one or more computers, comprising a stream table having entries for managing data within a data storage environment that are indexed according to an extended MIME typing that includes a general class, along with a general type and a specific type, and wherein said data storage environment includes at least one additional repository database, and wherein said repository databases within said data storage environment have stream connector entries for establishing a connection between said repository databases.

19. A repository database stored on one or more computers, comprising a system table space and a plurality of content table spaces, said system table space including a system stream table having entries for file data and for database data, such that said file data and said database data are managed within a same data storage environment.

20. The repository database of claim 19, wherein said system table space and said plurality of content table spaces each further include a plurality of abstract data type tables.

21. The repository database of claim 20, wherein said system table space and said plurality of content table spaces each further include a plurality of support table spaces.

22. The repository database of claim 19, wherein said system stream table further includes at least one stream connector entry for establishing a connection with another repository database.

23. A repository database stored on one or more computers, comprising a system table space and a plurality of content table spaces, said system table space including a system stream table having entries for file data and for database data, wherein said stream entries for said file data and for said database data are indexed according to an extended MIME typing that includes a storage class, along with a general type and a specific type, for distinctly typing said file data and said database data within a same data storage environment.

24. The repository database of claim 23, wherein said extended MIME typing further includes a general class for distinctly classifying kinds of content within said same data storage environment.

25. The repository database of claim 23, wherein said system table space and said plurality of content table spaces each further include a plurality of abstract data type tables.

26. The repository database of claim 25, wherein said system table space and said plurality of content table spaces each further include a plurality of support table spaces.

27. The repository database of claim 23, wherein said system stream table further includes at least one stream connector entry for establishing a connection with another repository database.

28. A repository database stored on one or more computers, comprising a system table space and a plurality of content table spaces, said system table space including a system stream table having entries for file data and for database data, wherein said stream entries for said file data and for said database data are indexed according to an extended MIME typing that includes a general class, along with a general type and a specific type, for distinctly classifying kinds of content within a same data storage environment.

29. The repository database of claim 28, wherein said system table space and said plurality of content table spaces each further include a plurality of abstract data type tables.

30. The repository database of claim 29, wherein said system table space and said plurality of content table spaces each further include a plurality of support table spaces.

31. The repository database of claim 28, wherein said system stream table further includes at least one stream connector entry for establishing a connection with another repository database.

32. A repository database stored on one or more computers, comprising a system table space and a plurality of content table spaces, said system table space including a system stream table having entries for file data and for database data, such that said file data and said database data are managed within a same data storage environment, and said plurality of content table spaces each including a content table space stream table, wherein said system stream table and said content table space stream tables further include stream connector entries for establishing connections therebetween.

33. The repository database of claim 32, wherein said system table space and said plurality of content table spaces each further include a plurality of abstract data type tables.

34. The repository database of claim 33, wherein said system table space and said plurality of content table spaces each further include a plurality of support table spaces.

35. The repository database of claim 32, wherein said system stream table further includes at least one stream connector entry for establishing a connection with another repository database.

36. A repository database stored on one or more computers, comprising a system table space and a plurality of content table spaces, said system table space including a system stream table having entries for file data and for database data, wherein said stream entries for said file data and for said database data are indexed according to an extended MIME typing that includes a storage class, along with a general type and a specific type, for distinctly typing said file data and said database data within a same data storage environment, and said plurality of content table spaces each including a content table space stream table, wherein said system stream table and said content table space stream tables further include stream connector entries for establishing connections therebetween.

37. The repository database of claim 36, wherein said extended MIME typing further includes a general class for distinctly classifying kinds of content within said same data storage environment.

38. The repository database of claim 36, wherein said system table space and said plurality of content table spaces each further include a plurality of abstract data type tables.

39. The repository database of claim 38, wherein said system table space and said plurality of content table spaces each further include a plurality of support table spaces.

40. The repository database of claim 36, wherein said system stream table further includes at least one stream connector entry for establishing a connection with another repository database.

41. A repository database stored on one or more computers, comprising a system table space and a plurality of content table spaces, said system table space including a system stream table having entries for file data and for database data, wherein said stream entries for said file data and for said database data are indexed according to an extended MIME typing that includes a general class, along with a general type and a specific type, for distinctly classifying kinds of content within a same data storage environment, and said plurality of content table spaces each including a content table space stream table, wherein said system stream table and said content table space stream tables further include stream connector entries for establishing connections therebetween.

42. The repository database of claim 41, wherein said system table space and said plurality of content table spaces each further include a plurality of abstract data type tables.

43. The repository database of claim 42, wherein said system table space and said plurality of content table spaces each further include a plurality of support table spaces.

44. The repository database of claim 41, wherein said system stream table further includes at least one stream connector entry for establishing a connection with another repository database.

45. A stream table stored on one or more computers for managing data within a data storage environment, comprising entries for file data and for database data, such that said file data and said database data are managed within a same data storage environment.

46. The stream table of claim 45, further comprising at least one stream connector entry for establishing a connection with another stream table.

47. A stream table stored on one or more computers for managing data within a data storage environment, comprising stream entries for file data and for database data, wherein said stream entries for said file data and for said database data are indexed according to an extended MIME typing that includes a storage class, along with a general type and a specific type, for distinctly typing said file data and said database data within a same said data storage environment.

48. The stream table of claim 47, wherein said extended MIME typing further includes a general class for distinctly classifying kinds of content within said same data storage environment.

49. The stream table of claim 47, further comprising at least one stream connector entry for establishing a connection with another stream table.

50. A stream table stored on one or more computers for managing data within a data storage environment, comprising stream entries for file data and for database data, wherein said stream entries for said file data and for said database data are indexed according to an extended MIME typing that includes a general class, along with a general type and a specific type, for distinctly classifying kinds of content within a same data storage environment

51. The stream table of claim 50, further comprising at least one stream connector entry for establishing a connection with another stream table.

52. A method for managing data in a repository portal including a file repository module, a repository database and a set of APIs, comprising the operations:
storing file data in a file repository module of said repository portal;
storing database data in a repository database of said repository portal; and
indexing each of said file data and said database data in a same stream table for managing said file data and said database data in a same data storage environment.

53. The method of claim 52, further comprising the operation running a set of API's for permitting interfacing between the repository portal and a computer network.

54. A method for managing data in a repository portal including a file repository module, a repository database and a set of APIs, comprising the operations:
storing file data in a file repository module of said repository portal;
storing database data in a repository database of said repository portal; and
indexing each of said file data and said database data according to an extended MIME typing that includes a storage class, along with a general type and a specific type, for distinctly typing said file data and said database data within a same data storage environment.

55. The method of claim 54, wherein said indexing operation comprises the operation storing entries for each of said file data and said database data in a same stream table for managing said file data and said database data in said same data storage environment.

56. The method of claim 55, further comprising the operation running a set of API's for permitting interfacing between the repository portal and a computer network.

57. The method of claim 54, wherein said extended MIME typing further includes a general class for distinctly classifying different kinds of content within said same data storage environment.

58. A method for managing data in a repository portal including a file repository module, a repository database and a set of APIs, comprising the operations:
storing file data in a file repository module of said repository portal;
storing database data in a repository database of said repository portal; and
indexing each of said file data and said database data according to an extended MIME typing that includes a general class, along with a general type and a specific type, for distinctly classifying kinds of content within a same data storage environment.

59. The method of claim 58, wherein said indexing operation comprises the operation storing entries for each of said file data and said database data in a same stream table for managing said file data and said database data in said same data storage environment.

60. The method of claim 59, further comprising the operation running a set of API's for permitting interfacing between the repository portal and a computer network.

61. A method for managing data, comprising the operations:
storing file data;
storing database data; and
indexing each of said file data and said database data in a same stream table for managing said file data and said database data in a same data storage environment.

62. A method for managing data, comprising the operations:
storing file data;
storing database data; and
indexing each of said file data and said database data according to an extended MIME typing that includes a storage class, along with a general type and a specific type, for distinctly typing said file data and said database data within a same data storage environment.

63. The method of claim 62, wherein said extended MIME typing further includes a general class for distinctly classifying different kinds of content within said same data storage environment.

64. A method for managing data, comprising the operations:
storing file data;
storing database data; and
indexing each of said file data and said database data according to an extended MIME typing that includes a storage class, along with a general type and a specific type, for distinctly typing said file data and said database data within a same data storage environment, wherein said indexing operation comprises storing entries for each of said file data and said database data in a same stream table for managing said file data and said database data in said same data storage environment.

65. The method of claim 64, wherein said extended MIME typing further includes a general class for distinctly classifying different kinds of content within said same data storage environment.

66. A method for managing data, comprising the operations:
storing file data;
storing database data; and
indexing each of said file data and said database data according to an extended MIME typing that includes a general class, along with a general type and a specific type, for distinctly classifying different kinds of content within a same data storage environment.

67. A method for managing data, comprising the operations:
storing file data;
storing database data; and
indexing each of said file data and said database data according to an extended MIME typing that includes a general class, along with a general type and a specific type, for distinctly classifying different kinds of content within a same data storage environment, wherein said indexing operation comprises storing entries for each of said file data and said database data in a same stream table for managing said file data and said database data in said same data storage environment.

68. A method for managing data, comprising indexing each of file data and database data in a same stream table for managing said file data and said database data in a same data storage environment.

69. A method for managing data, comprising indexing each of file data and database data according to an extended MIME typing that includes a storage class, along with a general type and a specific type, for distinctly typing said file data and said database data within a same data storage environment.

70. The method of claim 69, wherein said extended MIME typing further includes a general class for distinctly classifying different kinds of content within said same data storage environment.

71. A method for managing data, comprising indexing each of file data and database data according to an extended MIME typing that includes a storage class, along with a general type and a specific type, for distinctly typing said file data and said database data within a same data storage environment, wherein said indexing operation comprises storing entries for each of said file data and said database data in a same stream table for managing said file data and said database data in said same data storage environment.

72. The method of claim 71, wherein said extended MIME typing further includes a general class for distinctly classifying different kinds of content within said same data storage environment.

73. A method for managing data, comprising indexing each of file data and database data according to an extended MIME typing that includes a general class, along with a general type and a specific type, for distinctly classifying different kinds of content within a same data storage environment.

74. A method for managing data, comprising indexing each of file data and database data according to an extended MIME typing that includes a general class, along with a general type and a specific type, for distinctly classifying different kinds of content within a same data storage environment, wherein said indexing operation comprises storing entries for each of said file data and said database data in a same stream table for managing said file data and said database data in said same data storage environment.

75. A recording medium having a software algorithm stored thereon for providing instructions for one or more processors to perform the method of any of claims 52-74.

76. A computer system comprising one or more processors and having a software algorithm stored therein for providing instructions for the one or more processors to perform the method of any of claims 52-74.
